(19) United States
(12) Patent Application Publication
(10) Pub. No.: US 2016/0159281 A1
(43) Pub. Date: Jun. 9, 2016

(54) VEHICLE AND CONTROL METHOD THEREOF

(71) Applicant: Hyundai Mobis Co., Ltd., Seoul (KR)

(72) Inventors: Min soo JANG, Yongin-si (KR); Sung joo LEE, Yongin-si (KR); Sea young HEO, Yongin-si (KR)

(21) Appl. No.: 14/938,533

(22) Filed: Nov. 11, 2015

(30) Foreign Application Priority Data
Dec. 4, 2014 (KR) 10-2014-0172994
Dec. 18, 2014 (KR) 10-2014-0182929
Dec. 18, 2014 (KR) 10-2014-0182930
Dec. 18, 2014 (KR) 10-2014-0182931
Dec. 18, 2014 (KR) 10-2014-0182932
Jan. 19, 2015 (KR) 10-2015-0008907

(51) Int. Cl. B60R 1/00; B60R 11/04; H04N 7/18

(52) U.S. Cl. CPC B60R 1/00; H04N 7/181; B60R 11/04; B60R 2300/105; B60R 2300/304; B60R 2300/8093

(57) ABSTRACT

Disclosed is a vehicle, including a display device; one or more cameras; and a controller configured to combine a plurality of images received from the one or more cameras and switch the combined image to a top view image to generate an around view image, detect an object from at least one of the plurality of images and the around view image, determine a weighted value of two images obtained from two cameras of the one or more cameras when an object is located in an overlapping area in views of the two cameras, assign a weighted value to a specific image of the two images from the two cameras with the overlapping area, and display the specific image with the assigned weighted value and the around view image on the display device.

### CROSS-REFERENCE TO RELATED APPLICATION

This application claim priority from and the benefit of Korean Patent Application No. 10-2014-0172994, filed on Dec. 4, 2014, Korean Patent Application Nos. 10-2014-0182929, 10-2014-0182930, 10-2014-0182931, 10-2014-0182932, filed on Dec. 18, 2014, and Korean Patent Application No. 10-2015-0008907 filed Jan. 19, 2015, all of which are hereby incorporated by reference for all purposes as if fully set forth herein.

### BACKGROUND

1. Field

The present disclosure relates to a vehicle including an around view monitoring (AVM) apparatus displaying an image of the surroundings of a vehicle.

2. Discussion of the Background

An AVM apparatus is a system that may obtain an image of the vehicle surrounding through cameras mounted on the vehicle, and enabling a driver to check the surrounding area of the vehicle through a display device mounted inside the vehicle when the driver parks the vehicle. Further, the AVM system also provides an around view similar to a view above the vehicle by combining one or more images. A driver may recognize the situation around the vehicle by viewing the display device mounted inside the vehicle and safely park the vehicle, or pass through a narrow road by using the AVM system.

The AVM apparatus may also be utilized as a parking assisting apparatus, and also to detect an object based on images obtained through the cameras. Research on the operation of detecting an object through one or more cameras mounted in the AVM apparatus is required.

The above information disclosed in this Background section is only for enhancement of understanding of the background of the inventive concept, and, therefore, it may contain information that does not form the prior art that is already known in this country to a person of ordinary skill in the art.

### SUMMARY

The present disclosure has been made in an effort to provide a vehicle, which detects an object from images received from one or more cameras.

Additional aspects will be set forth in the detailed description which follows, and, in part, will be apparent from the disclosure, or may be learned by practice of the inventive concept.

Objects of the present disclosure are not limited to the objects described above, and other objects that are not described will be clearly understood by a person skilled in the art from the description below.

An exemplary embodiment of the present disclosure provides a vehicle that includes a vehicle a display device, one or more cameras, and a controller. The controller may be configured to combine a plurality of images received from the one or more cameras and switch the combined image to a top view image to generate an around view image, detect an object from at least one of the plurality of images and the around view image, determine a weighted value of two images obtained from two cameras of the one or more cameras when an object is located in an overlapping area in views of the two cameras, assign a weighted value to a specific image of the two images from the two cameras with the overlapping area, and display the specific image with the assigned weighted value and the around view image on the display device

An exemplary embodiment of the present disclosure provides a vehicle that includes a display device, one or more cameras, and a controller. The controller may be configured to combine a plurality of images received from the one or more cameras and switch the combined image to a top view image to generate an around view image, detect an object from at least one of the plurality of images and the generated around view image, determine a weighted value of two images obtained from two cameras of the one or more cameras based on a disturbance generated in the two cameras when the object is located in an overlapping area in views of the two cameras, and display the around view image on the display device.

An exemplary embodiment of the present disclosure provides a vehicle that includes a display device, one or more cameras, and a controller. The controller is configured to receive a plurality of images related to a surrounding area of the vehicle from one or more cameras, determine whether an object is detected from at least one of the plurality of images, determine whether the object is located in at least one of a plurality of overlap areas of the plurality of images, process the at least one of the plurality of overlap areas based on object detection information when the object is located in the overlap area, and perform blending processing on the at least one of the plurality of overlap areas according to a predetermined rate when the object is not detected or the object is not located in the at least one of the plurality of overlap areas to generate an around view image.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating an appearance of a vehicle including one or more cameras according to an exemplary embodiment of the present disclosure.

FIG. 2 is a diagram schematically illustrating a position of one or more cameras mounted in the vehicle of FIG. 1.

FIG. 3A illustrates an example of an around view image based on images photographed by one or more cameras of FIG. 2.

FIG. 3B is a diagram illustrating an overlap area according to an exemplary embodiment of the present disclosure.

FIG. 4 is a block diagram of the vehicle according to an exemplary embodiment of the present disclosure.

FIG. 5 is a block diagram of a display device according to an exemplary embodiment of the present disclosure.

FIG. 6A is a detailed block diagram of a controller according to a first exemplary embodiment of the present disclosure.

FIG. 6B is a flowchart illustrating the operation of a vehicle according to the first exemplary embodiment of the present disclosure.

FIG. 7A is a detailed block diagram of a controller and a processor according to a second exemplary embodiment of the present disclosure.

FIG. 7B is a flowchart illustrating the operation of a vehicle according to the second exemplary embodiment of the present disclosure.

FIGS. 8A, 8B, 8C, 8D, and 8E are photographs illustrating disturbance generated in a camera according to an exemplary embodiment of the present disclosure.

FIGS. 9A, 9B, 10A, 10B, 11A, 11B, 12A, 12B, and 12C are diagrams illustrating the operation of assigning a weighted value when an object is located in an overlap area according to an exemplary embodiment of the present disclosure.

FIG. 13 is a flowchart describing the operation of displaying an image obtained by a camera, to which a weighted value is further assigned, and an around view image on a display unit according to an exemplary embodiment of the present disclosure.

FIGS. 14A, 14B, 14C, and 14D are example diagrams illustrating the operation of displaying an image, obtained by a camera, to which a weighted value is further assigned, and an around view image on a display unit according to an exemplary embodiment of the present disclosure.

FIGS. 15A and 15B are diagrams illustrating the operation when a touch input for an object is received according to an exemplary embodiment of the present disclosure.

FIG. 16 is a detailed block diagram of a controller according to a third exemplary embodiment of the present disclosure.

FIG. 17 is a flowchart for describing the operation of a vehicle according to the third exemplary embodiment of the present disclosure.

FIGS. 18, 19, 20A, 20B, 21A, 21B, and 21C are diagrams illustrating the operation of generating an around view image by combining a plurality of images according to an exemplary embodiment of the present disclosure.

FIG. 22A is a detailed block diagram of a controller according to a fourth exemplary embodiment of the present disclosure.

FIG. 22B is a flowchart illustrating the operation of a vehicle according to the fourth exemplary embodiment of the present disclosure.

FIG. 23A is a detailed block diagram of a controller and a processor according to a fifth exemplary embodiment of the present disclosure.

FIG. 23B is a flowchart illustrating the operation of a vehicle according to the fifth exemplary embodiment of the present disclosure.

FIG. 24 is a conceptual diagram illustrating the division of an image into a plurality of areas and an object detected in the plurality of areas according to an exemplary embodiment of the present disclosure.

FIGS. 25A and 25B are concept diagrams illustrating an operation for tracking an object according to an exemplary embodiment of the present disclosure.

FIGS. 26A and 26B are example diagrams illustrating an around view image displayed on a display device according to an exemplary embodiment of the present disclosure.

FIG. 27A is a detailed block diagram of a controller according to a sixth exemplary embodiment of the present disclosure.

FIG. 27B is a flowchart for describing an operation of a vehicle according to the sixth exemplary embodiment of the present disclosure.

FIG. 28A is a detailed block diagram of a controller and a processor according to a seventh exemplary embodiment of the present disclosure.

FIG. 28B is a flowchart for describing the operation of a vehicle according to the seventh exemplary embodiment of the present disclosure.

FIG. 29 is an example diagram illustrating an around view image displayed on a display device according to an exemplary embodiment of the present disclosure.

FIGS. 30A and 30B are example diagrams illustrating an operation of displaying only a predetermined area in an around view image with a high quality according to an exemplary embodiment of the present disclosure.

FIG. 31 is a diagram illustrating an Ethernet backbone network according to an exemplary embodiment of the present disclosure.

FIG. 32 is a diagram illustrating an Ethernet Backbone network according to an exemplary embodiment of the present disclosure.

FIG. 33 is a diagram illustrating an operation when a network load is equal to or larger than a reference value according to an exemplary embodiment of the present disclosure.

### DETAILED DESCRIPTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms “first,” “second,” etc. may be used herein to describe various elements, components images, units (e.g., cameras) and/or areas, these elements, components, images, units, and/or areas should not be limited by these terms. These terms are used to distinguish one element, component, image, unit, and/or area from another element, component, image, unit, and/or area. Thus, a first element, component, image, unit, and/or area discussed below could be termed a second element, component, image, unit, and/or area without departing from the teachings of the present disclosure.

Spatially relative terms, such as “beneath,” “below,” “lower,” “above,” “upper,” “left,” “right,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “have,” “having,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Terms such as “module” and “unit” are suffixes for components used in the following description and are merely for the convenience of the reader. Unless specifically stated, these terms do not have a meaning distinguished from one another and may be used interchangeably.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

The vehicle described in the present specification may have a concept including all of an internal combustion engine vehicle including an engine as a power source, a hybrid electric vehicle including an engine and an electric motor as power sources, an electric vehicle including an electric motor as a power source, and the like.

In the description below, a left side of a vehicle means a left side in a travel direction of a vehicle, that is, a driver's seat side, and a right side of a vehicle means a right side in a travel direction of a vehicle, that is, a passenger's seat side.

An around view monitoring (AVM) apparatus described in the present specification may be an apparatus, which includes one or more cameras, combines a plurality of images photographed by the one or more cameras, and provides an around view image. Particularly, the AVM apparatus may be an apparatus for providing a top view or a bird eye view based on a vehicle. Hereinafter, an AVM apparatus for a vehicle according to various exemplary embodiments of the present disclosure and a vehicle including the same will be described.

In the present specification, data may be exchanged through a vehicle communication network. Here, the vehicle communication network may be a controller area network (CAN). According to an exemplary embodiment, the vehicle communication network is established by using an Ethernet protocol, but the specification is not limited thereto.

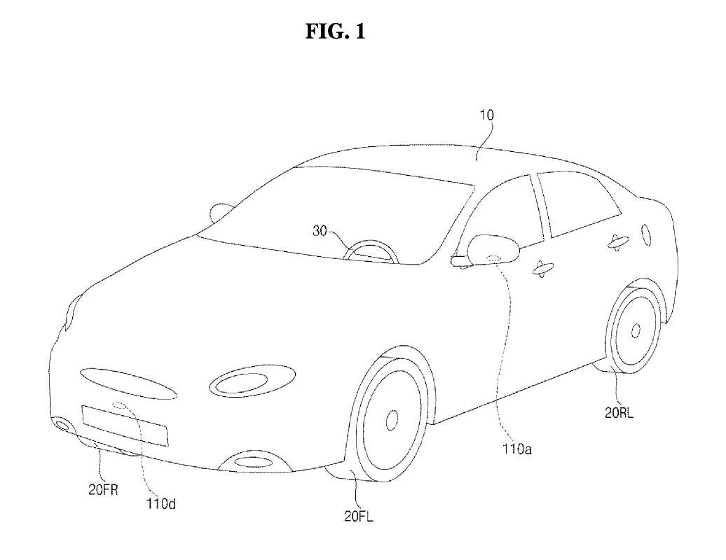

FIG. 1 is a diagram illustrating an appearance of a vehicle including one or more cameras according to an exemplary embodiment of the present disclosure.

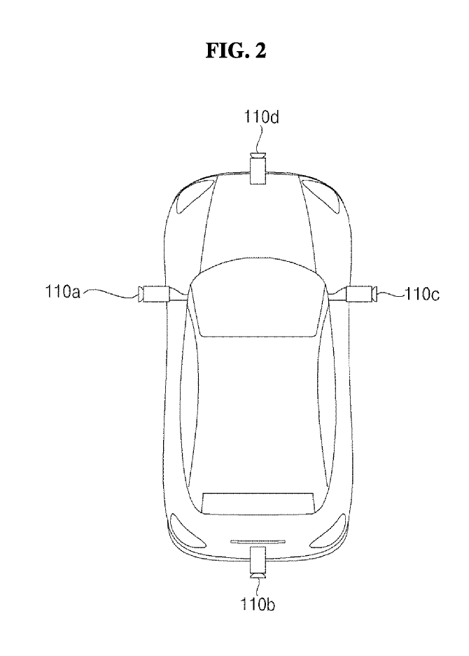

Referring to FIG. 1, a vehicle 10 may include wheels 20FR, 20FL, 20RL, . . . rotated by a power source, a steering wheel 30 for adjusting a movement direction of the vehicle 10, and one or more cameras 110a, 110b, 110c, and 110d mounted in the vehicle 10 (See FIG. 2). In FIG. 1, only a left camera 110a (also referred to as a first camera 110a) and a front camera 110d (also referred to as a fourth camera 110d) are illustrated for convenience.

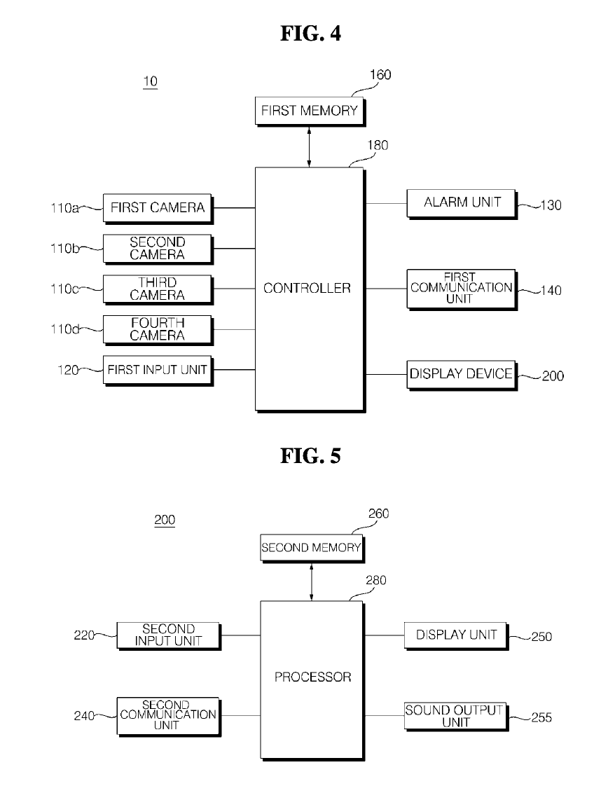

When the speed of the vehicle is equal to or smaller than a predetermined speed, or when the vehicle travels backward, the one or more cameras, 110a, 110b, 110c, and 110d, may be activated and obtain photographed images. The images obtained by the one or more cameras may be signal-processed by a controller 180 (see FIG. 4) or a processor 280 (see FIG. 5).

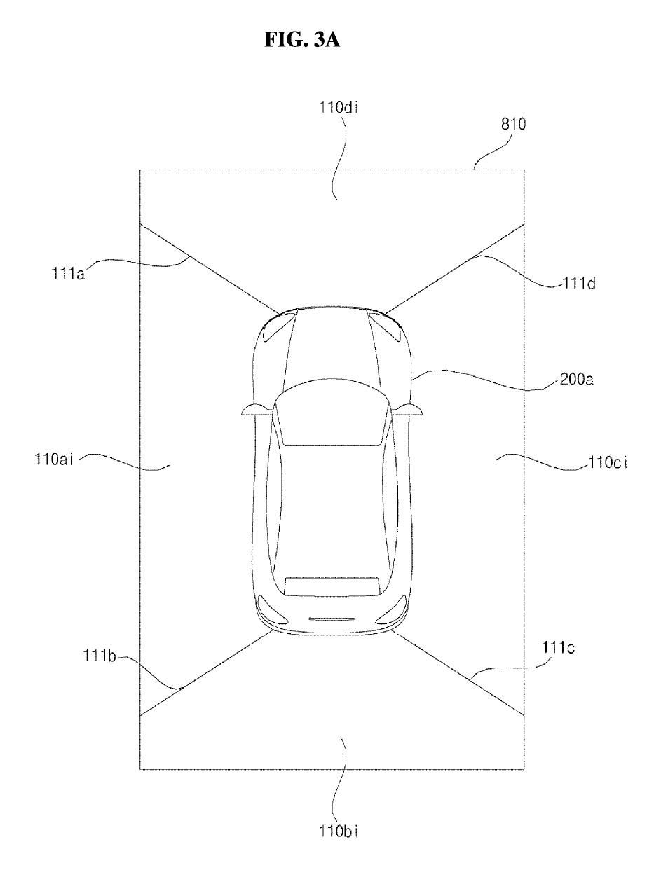

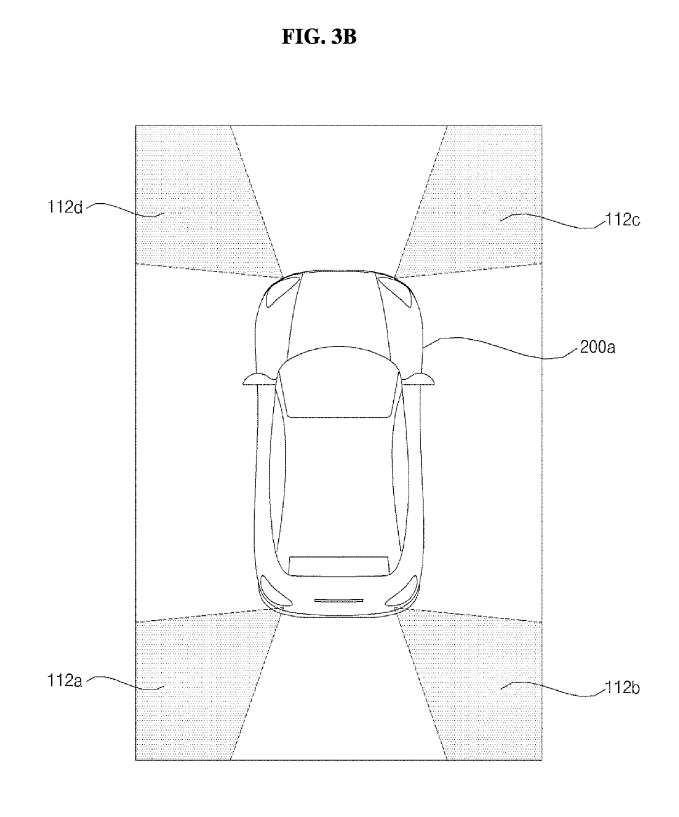

FIG. 2 is a diagram schematically illustrating a position of one or more cameras mounted in the vehicle of FIG. 1, and FIG. 3A illustrates an example of an around view image based on images photographed by one or more cameras of FIG. 2.

First, referring to FIG. 2, the one or more cameras, 110a, 110b, 110c, and 110d may be disposed at a left side, rear side, right side, and front side of the vehicle, respectively.

The left camera 110a and the right camera 110c (also referred to as the third camera 110c) may be disposed inside a case surrounding a left side mirror and the case surrounding the right side mirror, respectively.

The rear camera 110b (also referred to as the second camera 110b) and the front camera 110d may be disposed around a trunk switch and at an emblem or around the emblem, respectively.

The images photographed by the one or more cameras, 110a, 110b, 110c, and 110d, may be transmitted to the controller 180 (see FIG. 4) of the vehicle 10, and the controller 180 (see FIG. 4) may generate an around view image by combining the plurality of images.

FIG. 3A illustrates an example of an around view image based on images photographed by one or more cameras of FIG. 2.

Referring to FIG. 3A, the around view image 810 may include a first image area 110ai from the left camera 110a, a second image area 110bi from the rear camera 110b, a third image area 110ci from the right camera 110c, and a fourth image area 110di from the front camera 110d.

When the around view image is generated through one or more cameras, a boundary portion is generated between the respective image areas. The boundary portion is subjected to image blending processing in order to be naturally displayed.

Boundary lines 111a, 111b, 111c, and 111d may be displayed at boundaries of the plurality of images, respectively.

FIG. 3B is a diagram illustrating an overlap area according to an exemplary embodiment of the present disclosure.

Referring to FIG. 3B, one or more cameras may use a wide angle lens. Accordingly, an overlap area may be generated in the images obtained by one or more cameras. In exemplary embodiments, a first overlap area 112a may be generated in a first image obtained by the first camera 110a and a second image obtained by the second camera 110b. Further, a second overlap area 112b may be generated in the second image obtained by the second camera 110b and a third image obtained by the third camera 110c. Further, a third overlap area 112c may be generated in the third image obtained by the third camera 110c and a fourth image obtained by the fourth camera 110d. Further, a fourth overlap area 112d may be generated in a fourth image obtained by the fourth camera 110d and the first image obtained by the first camera 110a.

When an object is located in the first to fourth overlap areas 112a, 112b, 112c, and 112d, there may occur a phenomenon in which the objects are viewed as two objects or disappears when the images are converted into an around view image. In this case, a problem may occur in detecting an object, and information may be inaccurately delivered to the passenger.

FIG. 4 is a block diagram of the vehicle according to an exemplary embodiment of the present disclosure.

Referring to FIG. 4, the vehicle 10 may include the one or more cameras 110a, 110b, 110c, and 110d, a first input unit 120, an alarm unit 130, a first communication unit 140, a display device 200, a first memory 160, and a controller 180.

The one or more cameras may include first, second, third, and fourth cameras 110a, 110b, 110c, and 110d. The first camera 110a obtains an image around the left side of the vehicle. The second camera 110b obtains an image around the rear side of the vehicle. The third camera 110c obtains an image around the right side of the vehicle. The fourth camera 110d obtains an image around the front side of the vehicle. The plurality of images obtained by the first to fourth cameras 110a, 110b, 110c, and 110d, respectively, is transmitted to the controller 180.

Each of the first, second, third, and fourth cameras, 110a, 110b, 110c, and 110d, include a lens and an image sensor. The first, second, third, and fourth cameras, 110a, 110b, 110c, and 110d may include at least one of a charge-coupled device (CCD) and a complementary metal-oxide semiconductor (CMOS)). Here, the lens may be a fish-eye lens having a wide angle of 180° or more.

The first input unit 120 may receive a user's input. The first input unit 120 may include a means (such as at least one of a touch pad, a physical button, a dial, a slider switch, and a click wheel) configured to receive an input from the outside. The user's input received through the first input unit 120 is transmitted to the controller 180.

The alarm unit 130 outputs an alarm according to information processed by the controller 180. The alarm unit 130 may include a voice output unit and a display. The voice output unit may output audio data under the control of the controller 180. The sound output unit may include a receiver, a speaker, a buzzer, and the like. The display displays alarm information through a screen under the control of the controller 180.

The alarm unit 130 may output an alarm based on a position of a detected object. The display included in the alarm unit 130 may have a cluster and/or a head up display (HUD) on a front surface inside the vehicle.

The first communication unit 140 may communicate with an external electronic device, exchange data with an external server, a surrounding vehicle, an external base station, and the like. The first communication unit 140 may also include a communication module capable of establishing communication with an external electronic device. The communication module may use a publicly known technique.

The first communication unit 140 may include a short range communication module, and also exchange data with a portable terminal, and the like, of a passenger through the short range communication module. The first communication unit 140 may transmit an around view image to a portable terminal of a passenger. Further, the first communication unit 140 may transmit a control command received from a portable terminal to the controller 180. The first communication unit 140 may also transmit information according to the detection of an object to the portable terminal. In this case, the portable terminal may output an alarm notifying the detection of the object through an output of vibration, a sound, and the like.

The display device 200 displays an around view image by decompressing a compressed image. The display device 200 may be an audio video navigation (AVN) device. A configuration of the display device 200 will be described in detail with reference to FIG. 5.

The first memory 160 stores data supporting various functions of the vehicle 10. The first memory 160 may store a plurality of application programs driven in the vehicle 10, and data and commands for an operation of the vehicle 10.

The first memory 160 may include a high speed random access memory. The first memory 160 may include one or more non-volatile memories, such as a magnetic disk storage device, a flash memory device, or other non-volatile solid state memory device, but is not limited thereto, and may include a readable storage medium.

In exemplary embodiments, the first memory 160 may include an electronically erasable and programmable read only memory (EEP-ROM), but is not limited thereto. The EEP-ROM may be subjected to writing and erasing of information by the controller 180 during the operation of the controller 180. The EEP-ROM may be a memory device, in which information stored therein is not erased and is maintained even though the power supply of the control device is turned off and the supply of power is stopped.

The first memory 160 may store the image obtained from one or more cameras 110a, 110b, 110c, and 110d. In exemplary embodiments, when a collision of the vehicle 10 is detected, the first memory 160 may store the image obtained from one or more cameras 110a, 110b, 110c, and 110d.

The controller 180 controls the general operation of each unit within the vehicle 10. The controller 180 may perform various functions for controlling the vehicle 10, and execute or perform combinations of various software programs and/or commands stored within the first memory 160 in order to process data. The controller 180 may process a signal based on information stored in the first memory 160.

The controller 180 performs pre-processing on images received from one or more cameras 110a, 110b, 110c, and 110d. The controller 180 removes the noise in an image by using various filters or histogram equalization. However, pre-processing of the image is not an essential process, and may be omitted according to the state of the image or the image processing purpose.

The controller 180 generates an around view image based on the plurality of pre-processed images. Here, the around view image may be a top-view image. The controller 180 combines the plurality of images pre-processed by the controller 180, and switches the combined image to the around view image. According to an exemplary embodiment, the controller 180 may also combine the plurality of images, on which the pre-processing is not performed, and switch the combined image into the around view image. In exemplary embodiments, the controller 180 may combine the plurality of images by using a look up table (LUT), and switch the combined image into the around view image. The LUT is a table storing information corresponding to the relationship between one pixel of the combined image and a specific pixel of the four original images.

In exemplary embodiments, the controller 180 generates the around view image based on the first image from the left camera 110a, the second image from a rear camera 110b, the third image from the right camera 110c, and the fourth image from the front camera 110d. In this case, the controller 180 may perform blending processing on each of the overlap area between the first image and the second image, the overlap area between the second image and the third image, the overlap area between the third image and the fourth image, and the overlap image between the fourth image and the first image. The controller 180 may generate a boundary line at each of the boundary between the first image and the second image, the boundary between the second image and the third image, the boundary between the third image and the fourth image, and the boundary between the fourth image and the first image.

The controller 180 overlays a virtual vehicle image on the around view image. That is, since the around view image is generated based on the obtained image around the vehicle through one or more cameras mounted in the vehicle 10, the around view image does not include the image of the vehicle 10. The virtual vehicle image may be provided through the controller 180, thereby enabling a passenger to intuitively recognize the around view image.

The controller 180 may detect the object based on the around view image. Here, the object may be a concept including a pedestrian, an obstacle, a surrounding vehicle, and the like. The around view image displayed through the display device 200 may correspond to a partial area of the original images obtained through one or more cameras 110a, 110b, 110c, and 110d. The controller 180 may include the image displayed on the display device 200, and detect the object based on the all of the original images.

The controller 180 compares the detected object with an object stored in the first memory 160, and classifies and confirms the object.

The controller 180 tracks the detected object. In exemplary embodiments, the controller 180 may sequentially confirm the object within the obtained images, calculate a movement or a movement vector of the confirmed object, and track a movement of the corresponding object based on the calculated movement or movement vector.

The controller 180 determines whether the detected object is located in an overlap area in views from the two cameras. That is, the controller 180 determines whether the object is located in the first to fourth overlap areas 112a, 112b, 112c, and 112d of FIG. 3B. In exemplary embodiments, the controller 180 may determine whether the object is located in the overlap area based on whether the same object is detected from the images obtained by the two cameras.

When the object is located in the overlap area, the controller 180 may determine a weighted value of the image obtained from each of the two cameras. The controller 180 may then display an image after considering the weighed value to the around view image.

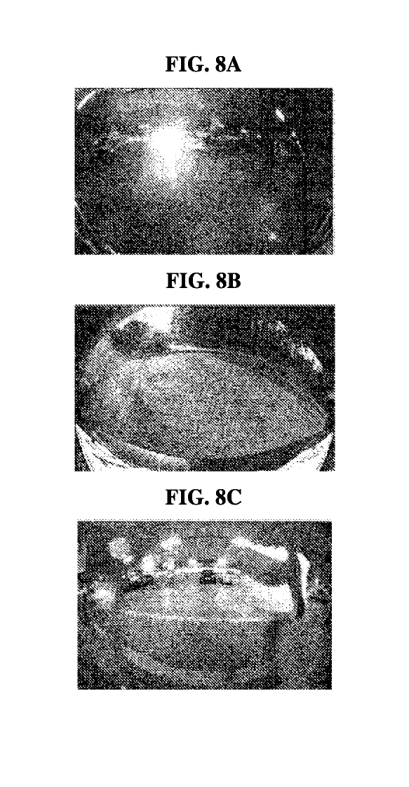

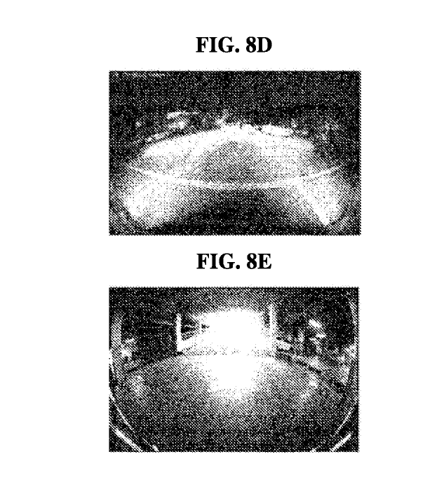

In exemplary embodiments, when a disturbance is generated in one camera between the two cameras, the controller 180 may assign a weighted value of 100% to the camera, in which disturbance is not generated. Here, the disturbance may be at least one of light inflow, exhaust gas generation, lens contamination, low luminance, image saturation, side mirror folding, and trunk open. The disturbance will be described in detail with reference to FIGS. 8A, 8B, 8C, 8D, and 8E.

In exemplary embodiments, the controller 180 may determine a weighted value by a score level method or a feature level method.

The score level method is a method of determining whether an object exists under an AND condition or an OR condition based on a final result of the detection of the object. Here, the AND condition may mean a case where an object is detected in all of the images obtained by the two cameras. Otherwise, the OR condition may mean a case where an object is detected in the image obtained by any one camera between the two cameras. If any one camera between the two cameras is contaminated, the controller 180 may detect the object when using the OR condition. The AND condition or the OR condition may be set by receiving a user's input. If a user desires to reduce sensitivity of a detection of an object, the controller 180 may reduce sensitivity of a detection of an object by setting the AND condition. In this case, the controller 180 may receive the user's input through the first input unit 120.

The feature level method is a method of detecting an object based on a feature of an object. Here, the feature may be movement speed, direction, or size of an object. In exemplary embodiments, when it is calculated that the first object moves two pixels per second in the fourth image obtained by the fourth camera 110d, and it is calculated that the first object moves four pixels per second in the first image obtained by the first camera 110a, the controller 180 may improve an object detection rate by setting a larger weighted value for the first image.

When a possibility that the first object exists in the fourth image is A %, the possibility that the first object exists in the first image is B %, and the weighted value is α, the controller 180 may determine whether an object exists by determining whether the calculated result O is equal to or larger than a reference value (for example, 50%) by using Equation 1 below.

O=αA+(1−α)B [Equation 1]

The weighted value may be a value set through a test of each case.

The controller 180 performs various tasks based on the around view image. In exemplary embodiments, the controller 180 may detect the object based on the around view image. Otherwise, the controller 180 may generate a virtual parking line in the around view image. Otherwise, the controller 180 may provide a predicted route of the vehicle based on the around view image. The performance of the application is not an essentially required process, and may be omitted according to a state of the image or an image processing purpose.

The controller 180 may perform an application operation corresponding to the detection of the object or the tracking of the object. In exemplary embodiments, the controller 180 may divide the plurality of images received from one or more cameras 110a, 110b, 110c, and 110d or the around view image into a plurality of areas, and determine a located area of the object in the plurality of images. In exemplary embodiments, when the detected object moves from an area corresponding to the first image obtained through the first camera 110a to an area corresponding to the second image obtained through the second camera 110b, the controller 180 may set an area of interest for detecting the object in the second image. Here, the controller 180 may detect the object in the area of interest with a top priority.

The controller 180 may overlay and display an image corresponding to the detected object on the around view image. The controller 180 may overlay and display an image corresponding to the tracked object on the around view image.

The controller 180 may assign a result of the determination of the weighted value to the around view image. According to the exemplary embodiment, when the object does not exist as a result of the assignment of the weighted value, the controller 180 may not assign the object to the around view image.

The controller 180 may display the image obtained by the camera, to which the weighted value is further assigned, on the display device 200 together with the around view image. The image obtained by the camera, to which the weighted value is further assigned, is an image, in which the detected object is more accurately displayed, so that a passenger may intuitively confirm information about the detected object.

The controller 180 may control zoom-in and zoom-out of one or more cameras 110a, 110b, 110c, and 110d in response to the user's input received through a second input unit 220 or a display unit 250 of the display device 200. In exemplary embodiments, when a touch input for the object displayed on the display unit 250 is received, the controller 180 may control at least one of one or more cameras 110a, 110b, 110c, and 110d to zoom in or zoom out.

FIG. 5 is a block diagram of the display device according to an exemplary embodiment of the present disclosure.

Referring to FIG. 5, the display device 200 may include the second input unit 220, a second communication unit 240, a display unit 250, a sound output unit 255, a second memory 260, and a processor 280.

The second input unit 220 may receive a user's input. The second input unit 220 may include a means, such as a touch pad, a physical button, a dial, a slider switch, and a click wheel, capable of receiving an input from the outside. The user's input received through the second input unit 220 is transmitted to the controller 180.

The second communication unit 240 may be communication-connected with an external electronic device to exchange data. In exemplary embodiments, the second communication unit 240 may be connected with a server of a broadcasting company to receive broadcasting contents. The second communication unit 240 may also be connected with a traffic information providing server to receive transport protocol experts group (TPEG) information.

The display unit 250 displays information processed by the processor 270. In exemplary embodiments, the display unit 250 may display execution screen information of an application program driven by the processor 270 or user interface (UI) and graphic user interface (GUI) information according to the execution screen information.

When the touch pad has a mutual layer structure with the display unit 250, the touch pad may be called a touch screen. The touch screen may perform a function as the second input unit 220.

The sound output unit 255 may output audio data. The sound output unit 255 may include a receiver, a speaker, a buzzer, or the like.

The second memory 260 stores data supporting various functions of the display device 200. The second memory 260 may store a plurality of application programs driven in the display device 200, and data and commands for an operation of the display device 200.

The second memory 260 may include a high speed random access memory, one or more non-volatile memories, such as a magnetic disk storage device, a flash memory device, or other non-volatile solid state memory device, but is not limited thereto, and may include a readable storage medium.

In exemplary embodiments, the second memory 260 may include an EEP-ROM, but is not limited thereto. The EEP-ROM may be subjected to writing and erasing of information by the processor 280 during the operation of the processor 280. The EEP-ROM may be a memory device, in which information stored therein is not erased and is maintained even though the power supply of the control device is turned off and the supply of power is stopped.

The processor 280 controls a general operation of each unit within the display device 200. The processor 280 may perform various functions for controlling the display device 200, and execute or perform combinations of various software programs and/or commands stored within the second memory 260 in order to process data. The processor 280 may process a signal based on information stored in the second memory 260.

The processor 280 displays the around view image.

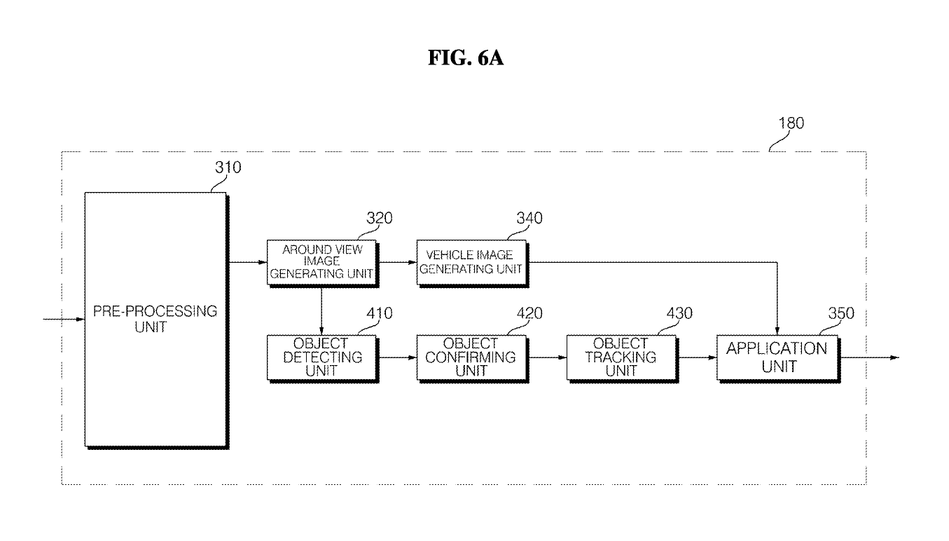

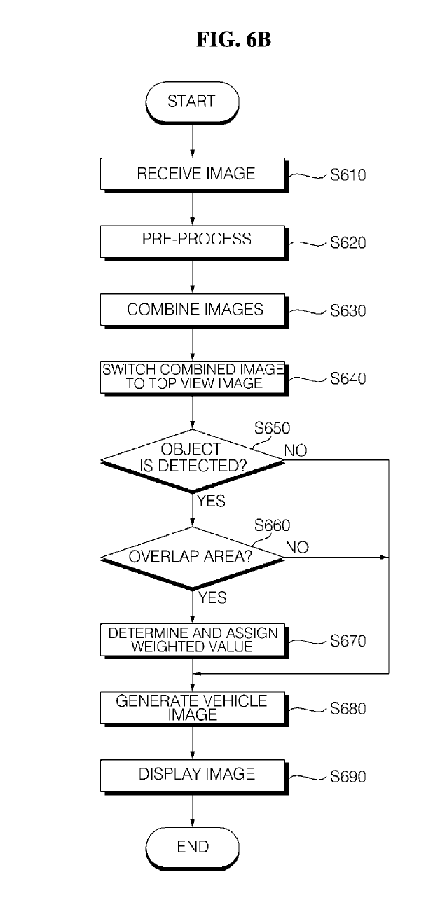

FIG. 6A is a detailed block diagram of a controller according to a first exemplary embodiment of the present disclosure.

Referring to FIG. 6A, the controller 180 may include a pre-processing unit 310, an around view image generating unit 320, a vehicle image generating unit 340, an application unit 350, an object detecting unit 410, an object confirming unit 420, an object tracking unit 430, and a determining unit 440.

The pre-processing unit 310 performs pre-processing on images received from one or more cameras 110a, 110b, 110c, and 110d. The pre-processing unit 310 removes the noise of an image by using various filters or histogram equalization. The pre-processing of the image is not an essentially required process, and may be omitted according to a state of the image or image processing purpose.

The around view image generating unit 320 generates an around view image based on the plurality of pre-processed images. Here, the around view image may be a top-view image. The around view image generating unit 320 combines the plurality of images pre-processed by the pre-processing unit 310, and switches the combined image to the around view image. According to an exemplary embodiment, the around view image generating unit 320 may also combine the plurality of images, on which the pre-processing is not performed, and switch the combined image into the around view image. In exemplary embodiments, the around view image generating unit 320 may combine the plurality of images by using a look up table (LUT), and switch the combined image into the around view image. The LUT is a table storing information corresponding to the relationship between one pixel of the combined image and a specific pixel of the four original images.

In exemplary embodiments, the around view image generating unit 320 generates the around view image based on a first image from the left camera 110a, a second image from a rear camera 110b, a third image from the right camera 110c, and a fourth image from the front camera 110d. In this case, the around view image generating unit 320 may perform blending processing on each of an overlap area between the first image and the second image, an overlap area between the second image and the third image, an overlap area between the third image and the fourth image, and an overlap image between the fourth image and the first image. The around view image generating unit 320 may generate a boundary line at each of a boundary between the first image and the second image, a boundary between the second image and the third image, a boundary between the third image and the fourth image, and a boundary between the fourth image and the first image.

The vehicle image generating unit 340 overlays a virtual vehicle image on the around view image. That is, since the around view image is generated based on the obtained image around the vehicle through one or more cameras mounted in the vehicle 10, the around view image does not include the image of the vehicle 10. The virtual vehicle image may be provided through the vehicle image generating unit 340, thereby enabling a passenger to intuitively recognize the around view image.

The object detecting unit 410 may detect an object based on the around view image. Here, the object may include a pedestrian, an obstacle, a surrounding vehicle, and the like. The around view image displayed through the display device 200 may correspond to a partial area of the original images obtained through one or more cameras 110a, 110b, 110c, and 110d. The object detecting unit 410 may include the image displayed on the display device 200, and detect the object based on the all of the original images.

The object confirming unit 420 compares the detected object with an object stored in the first memory 160, and classifies and confirms the object.

The object tracking unit 430 tracks the detected object. In exemplary embodiments, the object tracking unit 430 may sequentially confirm the object within the obtained images, calculate a movement or a movement vector of the confirmed object, and track a movement of the corresponding object based on the calculated movement or movement vector.

The determining unit 440 determines whether the detected object is located in an overlap area in views from the two cameras. That is, the determining unit 440 determines whether the object is located in the first to fourth overlap areas 112a, 112b, 112c, and 112d of FIG. 3B. In exemplary embodiments, the determining unit 440 may determine whether the object is located in the overlap area based on whether the same object is detected from the images obtained by the two cameras.

When the object is located in the overlap area, the determining unit 440 may determine a weighted value of the image obtained from each of the two cameras. The determining unit 440 may assign the weighted value to the around view image.

In exemplary embodiments, when disturbance is generated in one camera between the two cameras, the controller 180 may assign a weighted value of 100% to the camera, in which disturbance is not generated. Here, the disturbance may be at least one of light inflow, exhaust gas generation, lens contamination, low luminance, image saturation, side mirror folding, and trunk open. The disturbance will be described in detail with reference to FIGS. 8A, 8B, 8C, 8D, and 8E.

In exemplary embodiments, the determining unit 440 may determine a weighted value by a score level method or a feature level method.

The score level method is a method of determining whether an object exists under an AND condition or an OR condition based on a final result of the detection of the object. Here, the AND condition may mean a case where the object is detected in all of the images obtained by the two cameras. Otherwise, the OR condition may mean a case where an object is detected in the image obtained by any one camera between the two cameras. If any one camera between the two cameras is contaminated, the determining unit 440 may detect the object when using the OR condition. The AND condition or the OR condition may be set by receiving a user's input. If a user desires to reduce sensitivity of a detection of an object, the controller 180 may reduce sensitivity of a detection of an object by setting the AND condition. In this case, the controller 180 may receive a user's input through the first input unit 120.

The feature level method is a method of detecting an object based on a feature of an object. Here, the feature may be movement speed, direction, and size of an object. In exemplary embodiments, when it is calculated that the first object moves two pixels per second in the fourth image obtained by the fourth camera 110d, and it is calculated that the first object moves four pixels per second in the first image obtained by the first camera 110a, the determining unit 440 may improve an object detection rate by setting a larger weighted value for the first image.

When a possibility that the first object exists in the fourth image is A %, the possibility that the first object exists in the first image is B %, and the weighted value is α, the determining unit 440 may determine whether an object exists by determining whether the calculated result O is equal to or larger than a reference value (for example, 50%) by using Equation 1 below.

O=αA+(1−α)B [Equation 1]

The weighted value may be a value set through a test of each case.

The application unit 350 executes various applications based on the around view image. In exemplary embodiments, the application unit 350 may detect the object based on the around view image. Otherwise, the application unit 350 may generate a virtual parking line in the around view image. Otherwise, the application unit 350 may provide a predicted route of the vehicle based on the around view image. The performance of the application is not an essentially required process, and may be omitted according to a state of the image or an image processing purpose.

The application unit 350 may perform an application operation corresponding to the detection of the object or the tracking of the object. In exemplary embodiments, the application unit 350 may divide the plurality of images received from one or more cameras 110a, 110b, 110c, and 110d or the around view image into a plurality of areas, and determine a located area of the object in the plurality of images. In exemplary embodiments, when the detected object moves from an area corresponding to the first image obtained through the first camera 110a to an area corresponding to the second image obtained through the second camera 110b, the application unit 350 may set an area of interest for detecting the object in the second image. Here, the application unit 350 may detect the object in the area of interest with a top priority.

The application unit 350 may overlay and display an image corresponding to the detected object on the around view image. The application unit 350 may overlay and display an image corresponding to the tracked object on the around view image.

The application unit 350 may assign a result of the determination of the weighted value to the around view image. According to the exemplary embodiment, when the object does not exist as a result of the assignment of the weighted value, the application unit 350 may not assign the object to the around view image.

FIG. 6B is a flowchart illustrating the operation of a vehicle according to the first exemplary embodiment of the present disclosure.

Referring to FIG. 6B, the controller 180 receives an image from each of one or more cameras 110a, 110b, 110c, and 110d (S610).

The controller 180 performs pre-processing on each of the plurality of received images (S620). Next, the controller 180 combines the plurality of pre-processed images (S630), switches the combined image to a top view image (S640), and generates an around view image. According to an exemplary embodiment, the controller 180 may also combine the plurality of images, on which the pre-processing is not performed, and switch the combined image into the around view image. In exemplary embodiments, the controller 180 may combine the plurality of images by using a look up table (LUT), and switch the combined image into the around view image. The LUT is a table storing information corresponding to the relationship between one pixel of the combined image and a specific pixel of the four original images.

In a state where the around view image is generated, the controller 180 may detect an object based on the around view image. The around view image displayed through the display device 200 may correspond to a partial area of the original images obtained through one or more cameras 110a, 110b, 110c, and 110d. The controller 180 may include the image displayed on the display device 200, and detect the object based on the all of the original images (S650).

When a predetermined object is detected, the controller 180 determines whether the detected object is positioned in an overlap area in views from the two cameras (S660). When the object is located in the overlap area, the determining unit 440 may determine a weighted value of the image obtained from each of the two cameras. The determining unit 440 may assign the weighted value to the around view image (S670).

Then, the controller 180 generates a virtual vehicle image on the around view image (S680).

When the predetermined object is not detected, the controller 180 generates a virtual vehicle image on the around view image (S680). When the object is not located in the overlap area, the controller 180 generates a virtual vehicle image on the around view image (S680). Particularly, the controller 180 overlays the virtual vehicle image on the around view image.

Next, the controller 180 transmits compressed data to the display device 200 and displays the around view image (S690).

The controller 180 may overlay and display an image corresponding to the detected object on the around view image. The controller 180 may overlay and display an image corresponding to the tracked object on the around view image. In this case, the object may be an object, to which the weighted value is assigned in operation S670. According to the exemplary embodiment, when the object does not exist as a result of the assignment of the weighted value, the controller 180 may not assign the object to the around view image.

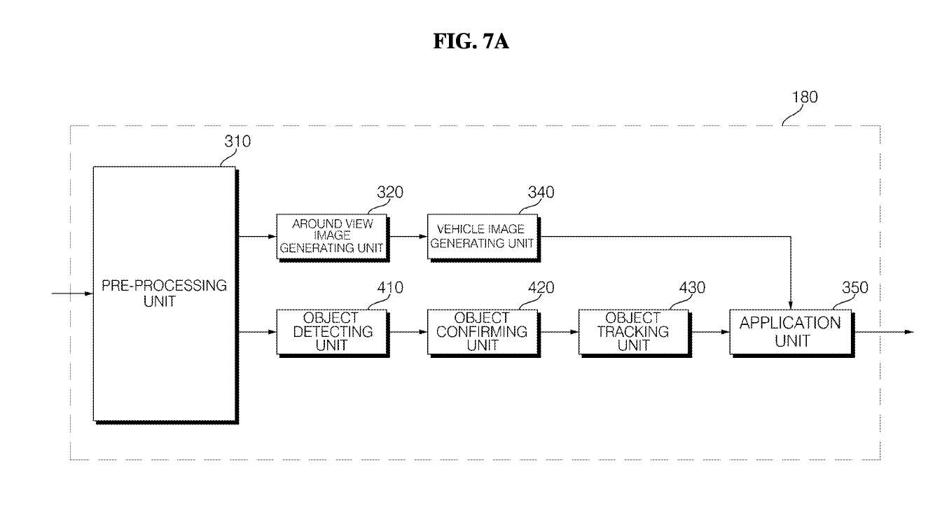

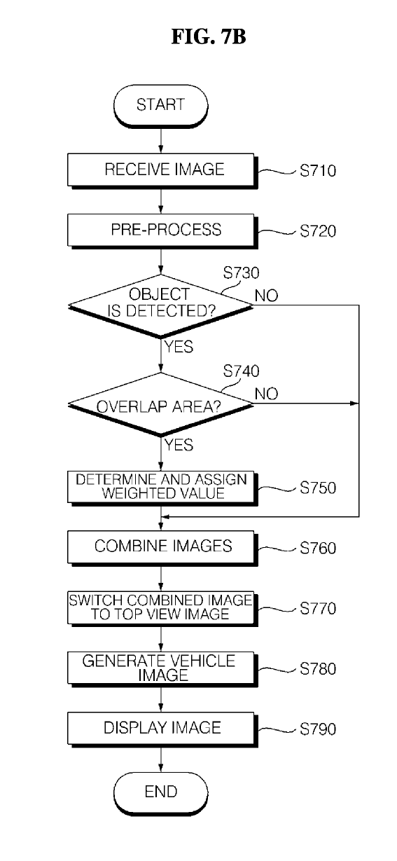

FIG. 7A is a detailed block diagram of a controller and a processor according to a second exemplary embodiment of the present disclosure.

The second exemplary embodiment is different from the first exemplary embodiment with respect to performance order. Hereinafter, a difference between the second exemplary embodiment and the first exemplary embodiment will be mainly described with reference to FIG. 7A.

The pre-processing unit 310 performs pre-processing on images received from one or more cameras 110a, 110b, 110c, and 110d. Then, the around view image generating unit 320 generates an around view image based on the plurality of pre-processed images. The vehicle image generating unit 340 overlays a virtual vehicle image on the around view image.

The object detecting unit 410 may detect an object based on the pre-processed image. The object confirming unit 420 compares the detected object with an object stored in the first memory 160, and classifies and confirms the object. The object tracking unit 430 tracks the detected object. The determining unit 440 determines whether the detected object is located in an overlap area in views from the two cameras. When the object is located in the overlap area, the determining unit 440 may determine a weighted value of the image obtained from each of the two cameras. The application unit 350 executes various applications based on the around view image. Further, the application unit 350 performs various applications based on the detected, confirmed, and tracked object. Further, the application unit 350 may assign the object, to which a weighted value is applied, to the around view image.

FIG. 7B is a flowchart illustrating the operation of a vehicle according to the second exemplary embodiment of the present disclosure.

The second exemplary embodiment is different from the first exemplary embodiment with respect to performance order. Hereinafter, a difference between the second exemplary embodiment and the first exemplary embodiment will be mainly described with reference to FIG. 7B.

The controller 180 receives an image from each of one or more cameras 110a, 110b, 110c, and 110d (S710).

The controller 180 performs pre-processing on each of the plurality of received images (S720).

Next, the controller 180 may detect an object based on the pre-processed images. The around view image displayed through the display device 200 may correspond to a partial area of the original images obtained through one or more cameras 110a, 110b, 110c, and 110d. The controller 180 may include the image displayed on the display device 200, and detect the object based on the all of the original images (S730).

When a predetermined object is detected, the controller 180 determines whether the detected object is located in an overlap area in views from the two cameras (S740). When the object is located in the overlap area, the determining unit 440 may determine a weighted value of the image obtained from each of the two cameras. The determining unit 440 may assign the weighted value to the around view image (S750).

Next, the controller 180 combines the plurality of pre-processed images (S760), switches the combined image to a top view image (S770), and generates an around view image.

When the predetermined object is not detected, the controller 180 combines the plurality of pre-processed images (S760), switches the combined image to a top view image (S770), and generates an around view image. When the object is not located in the overlap area, the controller 180 combines the plurality of pre-processed images (S760), switches the combined image to a top view image (S770), and generates an around view image. According to an exemplary embodiment, the controller 180 may also combine the plurality of images, on which the pre-processing is not performed, and switch the combined image into the around view image. In exemplary embodiments, the controller 180 may combine the plurality of images by using a look up table (LUT), and switch the combined image into the around view image. The LUT is a table storing information corresponding to the relationship between one pixel of the combined image and a specific pixel of the four original images.

Then, the controller 180 generates a virtual vehicle image on the around view image (S760). Particularly, the controller 180 overlays the virtual vehicle image on the around view image.

Next, the controller 180 transmits compressed data to the display device 200 and displays the around view image (S790).

The controller 180 may overlay and display an image corresponding to the detected object on the around view image. The controller 180 may overlay and display an image corresponding to the tracked object on the around view image. In this case, the object may be an object, to which the weighted value is assigned in operation S750. According to the exemplary embodiment, when the object does not exist as a result of the assignment of the weighted value, the controller 180 may not assign the object to the around view image.

FIGS. 8A, 8B, 8C, 8D, and 8E are photographs illustrating disturbance generated in a camera according to an exemplary embodiment of the present disclosure.

Referring to FIGS. 8A, 8B, 8C, 8D, and 8E, the disturbance may be at least one of light inflow, exhaust gas generation, lens contamination, low luminance, image saturation, side mirror folding, and trunk open. As illustrated in FIG. 8A, when light emitted from a lighting device of another vehicle is irradiated to the cameras 110a, 110b, 110c, and 110d, it may be difficult to obtain a normal image. Further when solar light is directly irradiated, it may be difficult to obtain a normal image. As described above, when light is directly incident to the cameras 110a, 110b, 110c, and 110d, the light acts as a noise while processing an image. In this case, this may degrade accuracy in processing an image, such as a detection of an object.

As illustrated in FIG. 8B, when exhaust gas is recognized in a view of the rear camera 110, it may be difficult to obtain a normal image. The exhaust gas acts as a noise while processing an image. In this case, this may degrade accuracy in processing an image, such as a detection of an object.

As illustrated in FIG. 8C, when a camera lens is contaminated by a predetermined material, it may be difficult to obtain a normal image. The materials act as noise while processing an image. In this case, this may degrade accuracy in processing an image, such as a detection of an object.

As illustrated in FIG. 8D, when appropriate luminance is not maintained, it may be difficult to obtain a normal image. In this case, this may degrade accuracy in processing an image, such as a detection of an object.

As illustrated in FIG. 8E, when an image is in a saturation state, it may be difficult to obtain a normal image. In this case, this may degrade accuracy in processing an image, such as a detection of an object.

Although not illustrated, when a side mirror is folded, in an embodiment where the first and third cameras 110a and 110c are mounted in the side mirror housing, it may be difficult to obtain a normal image. Further, when the trunk is open in an embodiment where the second camera 110b is mounted on the trunk, it may be difficult to obtain a normal image. In these cases, this may degrade the accuracy in the processing of an image, and may affect the detection of an object.

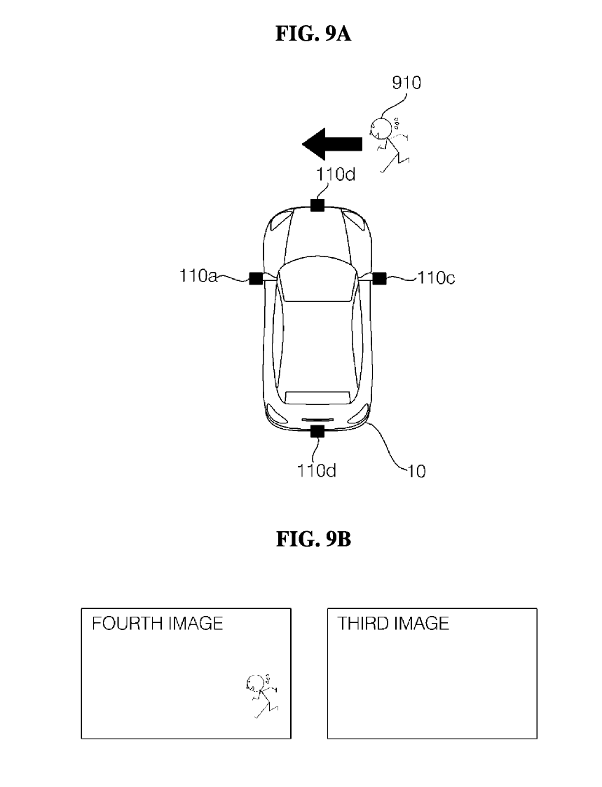

FIGS. 9A, 9B, 10A, 10B, 11A, 11B, 12A, 12B, and 12C are diagrams illustrating the operation of assigning a weighted value when an object is located in an overlap area according to an exemplary embodiment of the present disclosure.

As illustrated in FIG. 9A, in a state where the vehicle 10 stops, an object 910 may move from a right side to a left side of the vehicle.

In this case, as illustrated in FIG. 9B, the object 910 may be detected in the fourth image obtained by the fourth camera 110d. The object 910 may not be detected in the third image obtained by the third camera 110c. The reason is that the object 910 is not recognized at a viewing angle of the third camera 110c.

In this case, the controller 180 may set a weighted value by the score level method. That is, the controller 180 may determine whether the object is detected in the fourth image obtained by the fourth camera 110d and the third image obtained by the third camera 110c. Then, the controller 180 may determine whether the object is detected under the AND condition or the OR condition. When the weighted value is assigned under the AND condition, the object is not detected in the third image, so that the controller 180 may finally determine that the object is not detected, and perform a subsequent operation. When the weighted value is assigned under the OR condition, the object is detected in the fourth image, so that the controller 180 may finally determine that the object is detected, and perform a subsequent operation.

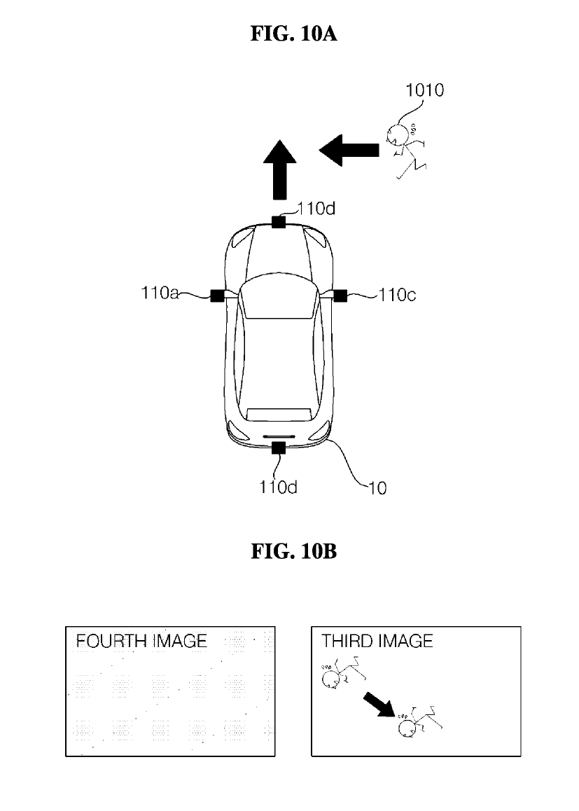

As illustrated in FIG. 10A, in a state where the vehicle 10 moves forward, the object 910 may move from the right side to the left side of the vehicle.

In this case, as illustrated in FIG. 10B, a disturbance is generated in the fourth camera 110d, so that an object 1010 may not be detected in the fourth image. An object 1010 may be detected in the third image obtained by the third camera 110c.

In this case, the controller 180 may set a weighted value by the score level method. That is, the controller 180 may determine whether the object is detected in the fourth image obtained by the fourth camera 110d and the third image obtained by the third camera 110c. Then, the controller 180 may determine whether the object is detected under the AND condition or the OR condition. When the weighted value is assigned under the AND condition, the object is not detected in the fourth image, so that the controller 180 may finally determine that the object is not detected, and perform a subsequent operation. When the weighted value is assigned under the OR condition, the object is detected in the third image, so that the controller 180 may finally determine that the object is detected, and perform a subsequent operation. When a disturbance is generated in the fourth camera, the weighted value may be assigned under the OR condition.

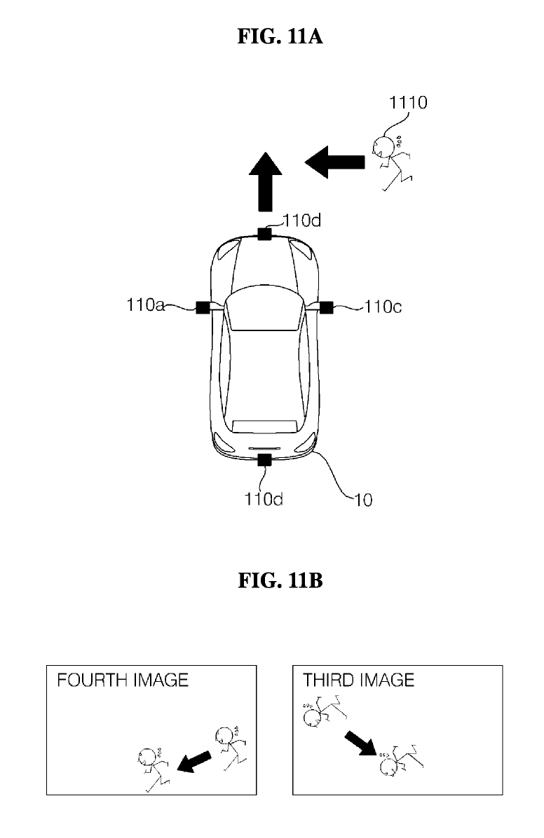

As illustrated in FIG. 11A, in a state where the vehicle 10 moves forward, the object 910 may move from the right side to the left side of the vehicle.

In this case, as illustrated in FIG. 11B, an object 1010 may be detected in the fourth image obtained by the fourth camera 110d. The object 1010 may be detected in the third image obtained by the third camera 110c.

In this case, the controller 180 may set a weighted value by the feature level method. In exemplary embodiments, the controller 180 may compare movement speeds, movement directions, or sizes of the objects, and set a weighted value.

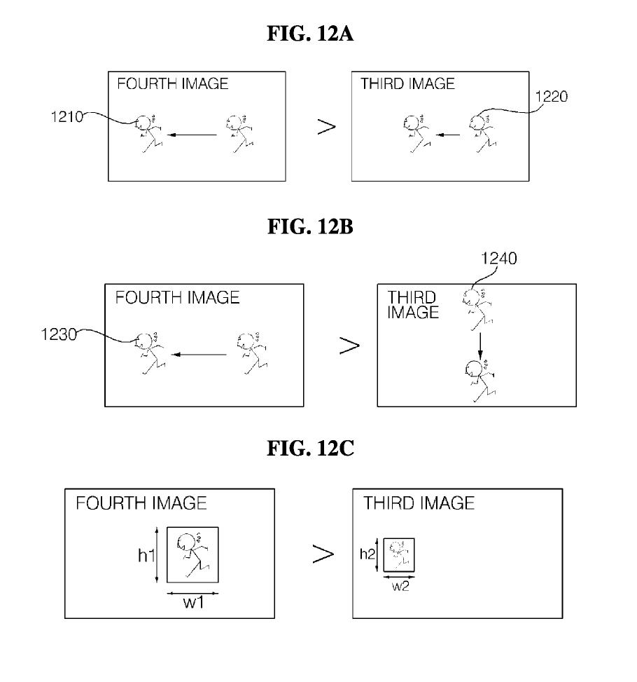

When a weighted value is determined based on a movement speed, as illustrated in FIG. 12A, the controller 180 may compare the fourth image with the third image, and assign a weighted value to an image having a larger pixel movement amount per unit time. When a pixel movement amount per unit time of an object 1210 in the fourth image is larger than a pixel movement amount per unit time of the object 1220 in the third image, the controller 180 may assign a larger weighted value to the fourth image.

When a weighted value is determined based on a movement direction, as illustrated in FIG. 12B, the controller 180 may compare the fourth image with the third image, and assign a weighted value to an image having larger horizontal movement. In vertical movement, the object actually approaches the vehicle 10, so that only the size of the object is increased. When horizontal movement of an object 1230 in the fourth image is larger than horizontal movement of an object 1240 in the third image, the controller 180 may assign a larger weighted value to the fourth image.

When a weighted value is determined by comparing sizes, as illustrated in FIG. 12C, the controller 180 may compare the fourth image with the third image, and further assign a weighted value to an image having a larger area of a virtual quadrangle surrounding the object. When an area of a virtual quadrangle surrounding an object 1240 in the fourth image is larger than an area of a virtual quadrangle surrounding an object 1260 in the third image, the controller 180 may assign a larger weighted value to the fourth image.

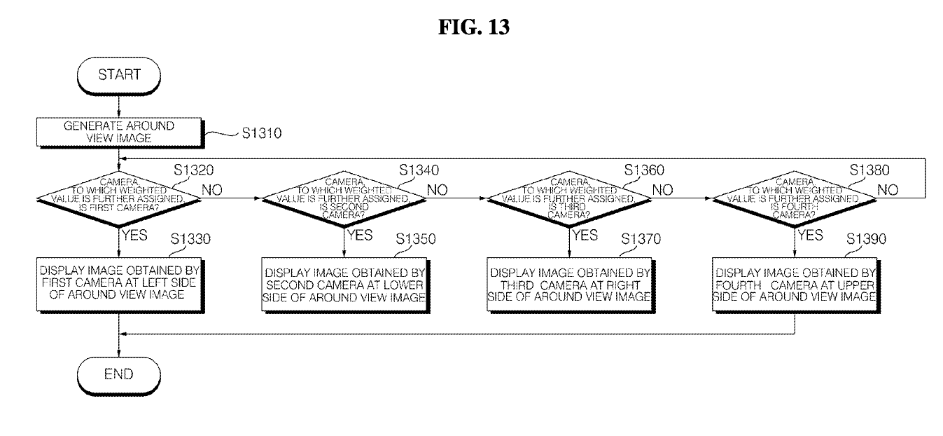

FIG. 13 is a flowchart describing the operation of displaying an image obtained by a camera, to which a weighted value is further assigned, and an around view image on a display unit according to an exemplary embodiment of the present disclosure.

Referring to FIG. 13, the controller 180 generates an around view image (S1310).

In a state where the around view image is generated, the controller 180 may display an image obtained by the camera, to which a weighted value is further assigned, and the around view image on the display device 200.

Particularly, in the state where the around view image is generated, the controller 180 determines whether the camera, to which the weighted value is further assigned, is the first camera 110a (S1320). When the first overlap area 112a (see FIG. 3B) is generated in the first image obtained by the first camera 110a and the second image obtained by the second camera 110b, and the weighted value is further assigned to the first image, the controller 180 may determine that the camera, to which the weighted value is further assigned, is the first camera 110a. Otherwise, when the fourth overlap area 112d (see FIG. 3B) is generated in the first image obtained by the first camera 110a and the fourth image obtained by the fourth camera 110d, and the weighted value is further assigned to the first image, the controller 180 may determine that the camera, to which the weighted value is further assigned, is the first camera 110a.

When the camera, to which the weighted value is further assigned, is the first camera 110a, the controller 180 controls the display device 200 so as to display the first image obtained by the first camera 110a at a left side of the around view image (S1330).

In the state where the around view image is generated, the controller 180 determines whether the camera, to which the weighted value is further assigned, is the second camera 110b (S1340). When the second overlap area 112b (see FIG. 3B) is generated in the second image obtained by the second camera 110b and the third image obtained by the third camera 110c, and the weighted value is further assigned to the second image, the controller 180 may determine that the camera, to which the weighted value is further assigned, is the second camera 110b. Otherwise, when the first overlap area 112a (see FIG. 3B) is generated in the second image obtained by the second camera 110b and the first image obtained by the first camera 110a, and the weighted value is further assigned to the second image, the controller 180 may determine that the camera, to which the weighted value is further assigned, is the second camera 110b.

When the camera, to which the weighted value is further assigned, is the second camera 110b, the controller 180 controls the display device 200 so as to display the second image obtained by the second camera 110b at a lower side of the around view image (S1350).

In the state where the around view image is generated, the controller 180 determines whether the camera, to which the weighted value is further assigned, is the third camera 110c (S1360). When the third overlap area 112c (see FIG. 3B) is generated in the third image obtained by the third camera 110c and the fourth image obtained by the fourth camera 110d, and the weighted value is further assigned to the third image, the controller 180 may determine that the camera, to which the weighted value is further assigned, is the third camera 110c. Otherwise, when the second overlap area 112b (see FIG. 3B) is generated in the third image obtained by the third camera 110c and the second image obtained by the second camera 110b, and the weighted value is further assigned to the third image, the controller 180 may determine that the camera, to which the weighted value is further assigned, is the third camera 110c.

When the camera, to which the weighted value is further assigned, is the third camera 110c, the controller 180 controls the display device 200 so as to display the third image obtained by the third camera 110c at a right side of the around view image (S1370).

In the state where the around view image is generated, the controller 180 determines whether the camera, to which the weighted value is further assigned, is the fourth camera 110d (S1380). When the fourth overlap area 112d (see FIG. 3B) is generated in the fourth image obtained by the fourth camera 110d and the first image obtained by the first camera 110a, and the weighted value is further assigned to the fourth image, the controller 180 may determine that the camera, to which the weighted value is further assigned, is the fourth camera 110b. Otherwise, when the third overlap area 112c (see FIG. 3B) is generated in the fourth image obtained by the fourth camera 110d and the third image obtained by the third camera 110c, and the weighted value is further assigned to the fourth image, the controller 180 may determine that the camera, to which the weighted value is further assigned, is the fourth camera 110d.

When the camera, to which the weighted value is further assigned, is the fourth camera 110d, the controller 180 controls the display device 200 so as to display the fourth image obtained by the fourth camera 110d at an upper side of the around view image (S1390).

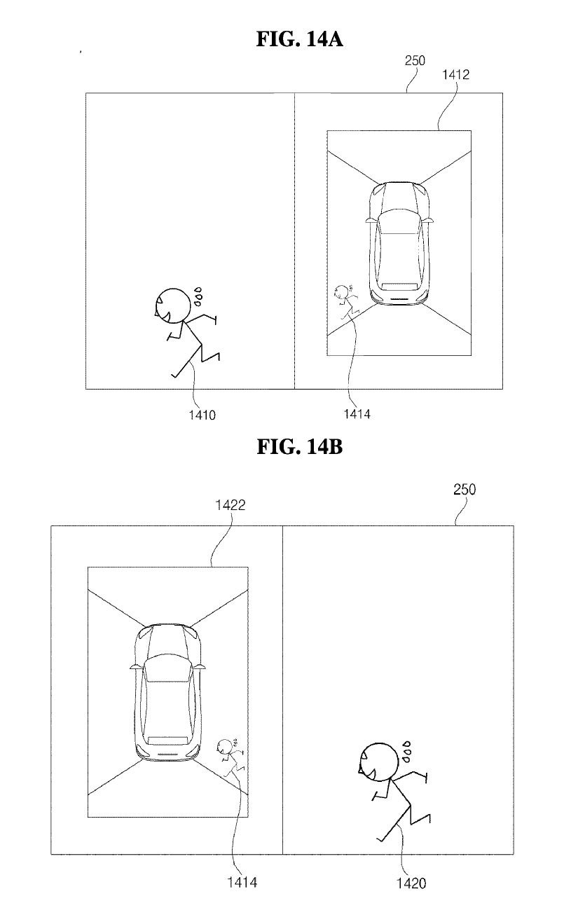

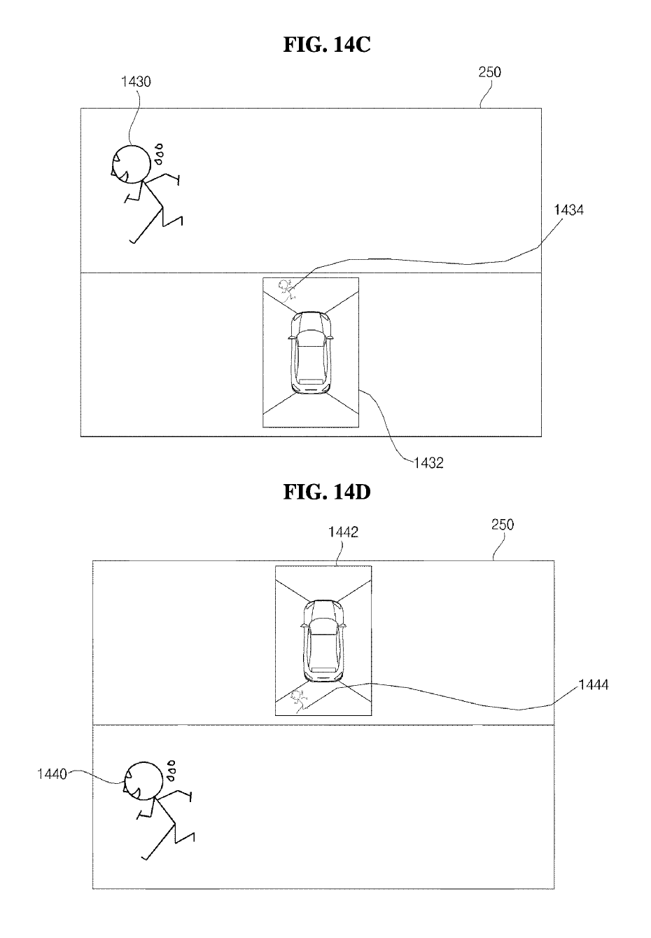

FIGS. 14A, 14B, 14C, and 14D are example diagrams illustrating the operation of displaying an image, obtained by a camera, to which a weighted value is further assigned, and an around view image on a display unit according to an exemplary embodiment of the present disclosure.

FIG. 14A illustrates an example of a case where the first overlap area 112a (see FIG. 3B) is generated in the first image obtained by the first camera 110a and the second image obtained by the second camera 110b, and a weighted value is further assigned to the first image. The controller 180 controls the first image obtained by the first camera 110a to be displayed on a predetermined area of the display unit 250 included in the display device 200. In this case, a first object 1410 is displayed in the first image. The controller 180 controls an around view image 1412 to be displayed on another area of the display unit 250. A first object 1414 may be displayed in the around view image 1412.

FIG. 14B illustrates an example of a case where the second overlap area 112b (see FIG. 3B) is generated in the third image obtained by the third camera 110c and the second image obtained by the second camera 110b, and a weighted value is further assigned to the third image. The controller 180 controls the third image obtained by the third camera 110c to be displayed on a predetermined area of the display unit 250 included in the display device 200. In this case, a second object 1420 is displayed in the third image. The controller 180 controls an around view image 1422 to be displayed on another area of the display unit 250. A second object 1424 may be displayed in the around view image 1422.

FIG. 14C illustrates an example of a case where the fourth overlap area 112d (see FIG. 3B) is generated in the fourth image obtained by the fourth camera 110d and the first image obtained by the first camera 110a, and a weighted value is further assigned to the fourth image. The controller 180 controls the fourth image obtained by the fourth camera 110d to be displayed on a predetermined area of the display unit 250 included in the display device 200. In this case, a third object 1430 is displayed in the fourth image. The controller 180 controls an around view image 1432 to be displayed on another area of the display unit 250. A third object 1434 may be displayed in the around view image 1432.

FIG. 14D illustrates an example of a case where the first overlap area 112a (see FIG. 3B) is generated in the second image obtained by the second camera 110b and the first image obtained by the first camera 110a, and a weighted value is further assigned to the second image. The controller 180 controls the second image obtained by the second camera 110b to be displayed on a predetermined area of the display unit 250 included in the display device 200. In this case, a fourth object 1440 is displayed in the second image. The controller 180 controls an around view image 1442 to be displayed on another area of the display unit 250. A fourth object 1444 may be displayed in the around view image 1442.

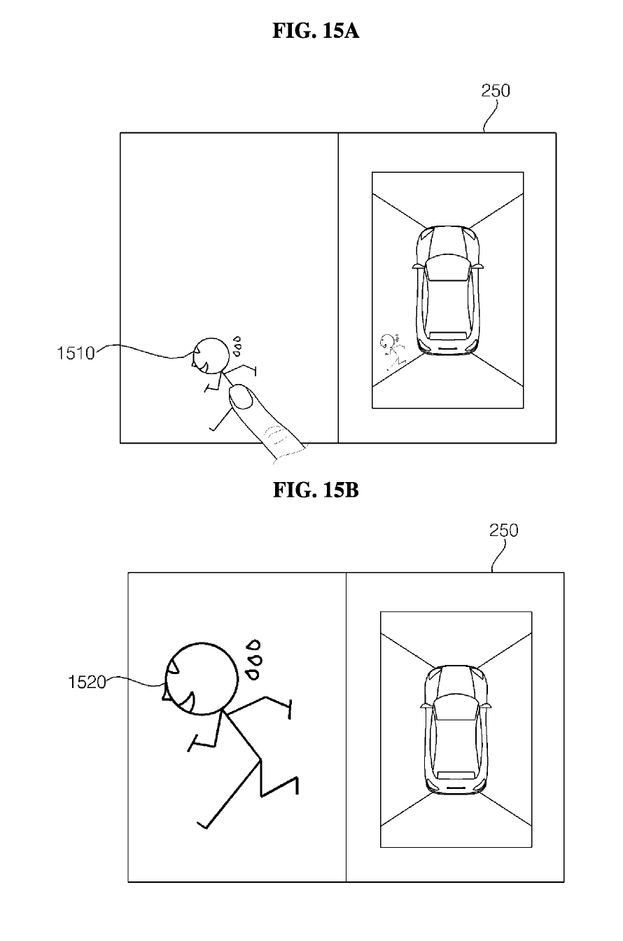

FIGS. 15A and 15B are diagrams illustrating the operation when a touch input for an object is received according to an exemplary embodiment of the present disclosure.

As illustrated in FIG. 15A, in a state where the first image obtained by the first camera 110a and the around view image are displayed, the controller 180 receives a touch input for an object 1510 of the first image.

In this case, as illustrated in FIG. 15B, the controller 180 may enlarge the object (1520), and display the enlarged object. When the touch input for the object 1510 of the first image is received, the controller 180 may enlarge the object (1520) and display the enlarged object by controlling the first camera 110a to zoom in and displaying an image in the zoom-in state on the display unit 250.

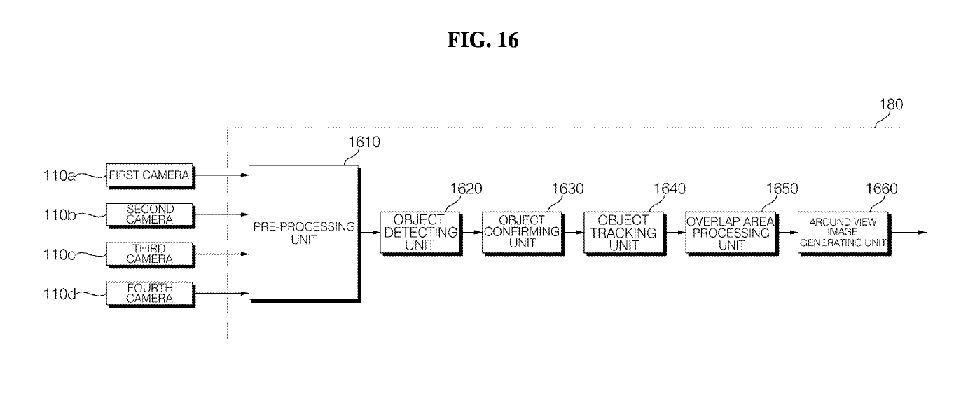

FIG. 16 is a detailed block diagram of a controller according to a third exemplary embodiment of the present disclosure.

Referring to FIG. 16, the controller 180 may include a pre-processing unit 1610, an object detecting unit 1620, an object confirming unit 1630, an object tracking unit 1640, an overlap area processing unit 1650, and an around view image generating unit 1660.

The pre-processing unit 1610 performs pre-processing on images received from one or more cameras 110a, 110b, 110c, and 110d. The pre-processing unit 1610 removes noise in an image by using various filters or histogram equalization. However, the pre-processing of the image is not an essential process, and may be omitted according to the state of the image or the image processing purpose.

The object detecting unit 1620 may detect an object based on the pre-processed image. Here, the object may include a pedestrian, an obstacle, a surrounding vehicle, and the like. The around view image displayed through the display device 200 may correspond to a partial area of the original images obtained through one or more cameras 110a, 110b, 110c, and 110d. The object detecting unit 1620 may include the image displayed on the display device 200, and detect the object based on the all of the original images.

The object confirming unit 1630 compares the detected object with an object stored in the first memory 160, and classifies and confirms the object.

The object tracking unit 1640 tracks the detected object. In exemplary embodiments, the object tracking unit 430 may sequentially confirm the object within the obtained images, calculate the movement or the movement vector of the confirmed object, and track the movement of the corresponding object based on the calculated movement or movement vector.

The overlap area processing unit 1650 processes an overlap area based on object detection information and combines the images.

When the object is detected in the overlap areas of the plurality of images, the overlap area processing unit 1650 compares movement speeds, movement directions, or sizes of the object in the plurality of images. The overlap area processing unit 1650 determines a specific image having higher reliability among the plurality of images based on a result of the comparison. The overlap area processing unit 1650 processes the overlap area based on reliability. The overlap area processing unit 1650 processes the overlap area with the image having the higher reliability among the plurality of images. In exemplary embodiments, when the object is detected in the overlap area of the first and second images, the overlap area processing unit 1650 compares the movement speed, movement direction, or size of the object in the first and second images. The overlap area processing unit 1650 determines a specific image having higher reliability between the first and second images based on the result of the comparison. The overlap area processing unit 1650 processes the overlap area with the image having higher reliability between the first and second images.

When the overlap area processing unit 1650 determines reliability based on the movement speed of the object, the overlap area processing unit 1650 may assign a higher reliability rating to an image having a larger pixel movement amount per unit time of the object among the plurality of images. In exemplary embodiments, when the object is detected in the overlap area of the first and second images, the overlap area processing unit 1650 may assign a higher reliability rating to an image having a larger pixel movement amount per unit time of the object between the first and second images.

When the overlap area processing unit 1650 determines reliability based on the movement direction of the object, the overlap area processing unit 1650 may assign higher reliability rating to an image having a larger horizontal movement of the object among the plurality of images. In vertical movement, the object actually approaches the vehicle, so that only a size of the object is increased, so vertical movement is disadvantageous compared to horizontal movement when object detection and tracking is concerned. In exemplary embodiments, when the object is detected in the overlap area of the first and second images, the overlap area processing unit 1650 may assign a higher reliability rating to an object having the larger horizontal movement between the first and second images.

When the overlap area processing unit 1650 determines reliability based on the size of the object, the overlap area processing unit 1650 may assign a higher reliability rating to an image having the larger number of pixels occupied by the object among the plurality of images. The overlap area processing unit 1650 may further assign a weighted value to an image having a larger area of a virtual quadrangle surrounding the object among the plurality of images. In exemplary embodiments, when the object is detected in the overlap area of the first and second images, the overlap area processing unit 1650 may assign a higher reliability rating to an image having the larger number of pixels occupied by the object between the first and second images.

When an object is not detected, or an object is not located in the overlap area, the overlap area processing unit 1650 may perform blending processing on the overlap area according to a predetermined rate, and combine the images.

The around view image generating unit 1660 generates an around view image based on the combined image. Here, the around view image may be an image obtained by combining the images received from one or more cameras 110a, 110b, 110c, and 110d photographing images around the vehicle and switching the combined image to a top view image.

In exemplary embodiments, the around view image generating unit 1660 may combine the plurality of images by using a look up table (LUT), and switch the combined image into the around view image. The LUT is a table storing information corresponding to the relationship between one pixel of the combined image and a specific pixel of the four original images.

Then, the around view image generating unit 1660 generates a virtual vehicle image on the around view image. Particularly, the around view image generating unit 1660 overlaps a virtual vehicle image on the around view image.

Next, the around view image generating unit 1660 transmits compressed data to the display device 200 and displays the around view image.

The around view image generating unit 1660 may overlay and display an image corresponding to the object detected in operation S730 on the around view image. The around view image generating unit 1660 may overlay and display an image corresponding to the tracked object on the around view image.

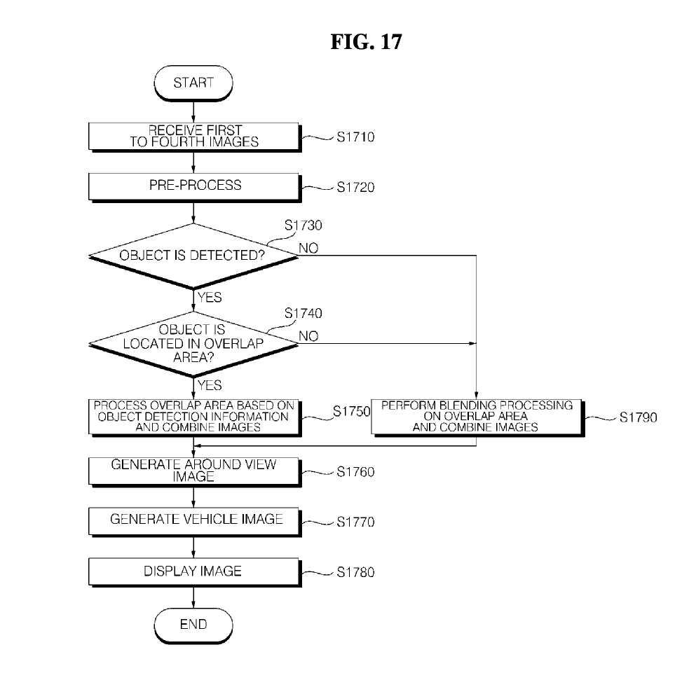

FIG. 17 is a flowchart for describing the operation of a vehicle according to the third exemplary embodiment of the present disclosure.

Referring to FIG. 17, the controller 180 receives first to fourth images from one or more cameras 110a, 110b, 110c, and 110d (S1710).

The controller 180 performs pre-processing on each of the plurality of received images (S1720). The controller 180 removes the noise of an image by using various filters or histogram equalization. The pre-processing of the image is not an essential process, and may be omitted according to a state of the image or the image processing purpose.

The controller 180 determines whether an object is detected based on the received first to fourth images or the pre-processed image (S1730). Here, the object may include a pedestrian, an obstacle, a surrounding vehicle, and the like.

When an object is detected, the controller 180 determines whether the object is located in an overlap area (S1740). Particularly, the controller 180 determines whether the object is located in any one of the first to fourth overlap areas 112a, 112b, 112c, and 112d described with reference to FIG. 3B.

When the object is located in the overlap areas 112a, 112b, 112c, and 112d, the controller 180 processes the overlap area based on object detection information and combines the images (S1750).

When an object is detected in the overlap areas of the plurality of images, the controller 180 compares the movement speed, movement direction, or size of the object in the plurality of images. The controller 180 determines a specific image having a higher reliability rating among the plurality of images based on a result of the comparison. The controller 180 processes the overlap area based on reliability. The controller 180 processes the overlap area only with the image having a higher reliability rating among the plurality of images. In exemplary embodiments, when an object is detected in the overlap area of the first and second images, the controller 180 compares the movement speed, movement direction, or size of the object in the first and second images. The controller 180 determines a specific image having a higher reliability rating between the first and second images based on a result of the comparison. The controller 180 processes the overlap area based on the reliability rating. The controller 180 processes the overlap area only with the image having a higher reliability rating between the first and second images.

When the controller 180 determines reliability based on the movement speed of the object, the controller 180 may assign a higher reliability rating to an image having a larger pixel movement amount per unit time of the object among the plurality of images. In exemplary embodiments, when an object is detected in the overlap area of the first and second images, the controller 180 may assign a higher reliability rating to an image having the larger pixel movement amount per unit time of the object between the first and second images.

When the controller 180 determines reliability based on the movement direction of the object, the controller 180 may assign a higher reliability rating to an image having a larger horizontal movement of the object among the plurality of images. In vertical movement, the object actually approaches the vehicle 10, so that only the size of the object is increased, so vertical movement is disadvantageous compared to horizontal movement when the object detection and tracking is concerned. In exemplary embodiments, when the object is detected in the overlap area of the first and second images, the controller 180 may assign a higher reliability rating to an image having the larger horizontal movement between the first and second images.

When the controller 180 determines reliability based on the size of the object, the controller 180 may assign a higher reliability rating to an image having the larger number of pixels occupied by the object among the plurality of images. The controller 180 may further assign a weighted value to an image having a larger area of a virtual quadrangle surrounding the object among the plurality of images. In exemplary embodiments, when the object is detected in the overlap area of the first and second images, the controller 180 may assign a higher reliability rating to an image having the larger number of pixels occupied by the object between the first and second images.

Next, the controller 180 generates an around view image based on the combined image (S1760). Here, the around view image may be an image obtained by combining the images received from one or more cameras 110a, 110b, 110c, and 110d photographing images around the vehicle and switching the combined image to a top view image.

In exemplary embodiments, the controller 180 may combine the plurality of images by using a look up table (LUT), and switch the combined image into the around view image. The LUT is a table storing information corresponding to the relationship between one pixel of the combined image and a specific pixel of the four original images.

Then, the controller 180 generates a virtual vehicle image on the around view image (S1770). Particularly, the controller 180 overlays the virtual vehicle image on the around view image.

Next, the controller 180 transmits compressed data to the display device 200 and displays the around view image (S1780).

The controller 180 may overlay and display an image corresponding to the object detected in operation S1730 on the around view image. The controller 180 may overlay and display an image corresponding to the tracked object on the around view image.

When the object is not detected in operation S1730, or the object is not located in the overlap area in operation S1740, the controller 180 may perform blending processing on the overlap area according to a predetermined rate, and combine the images (S1790).

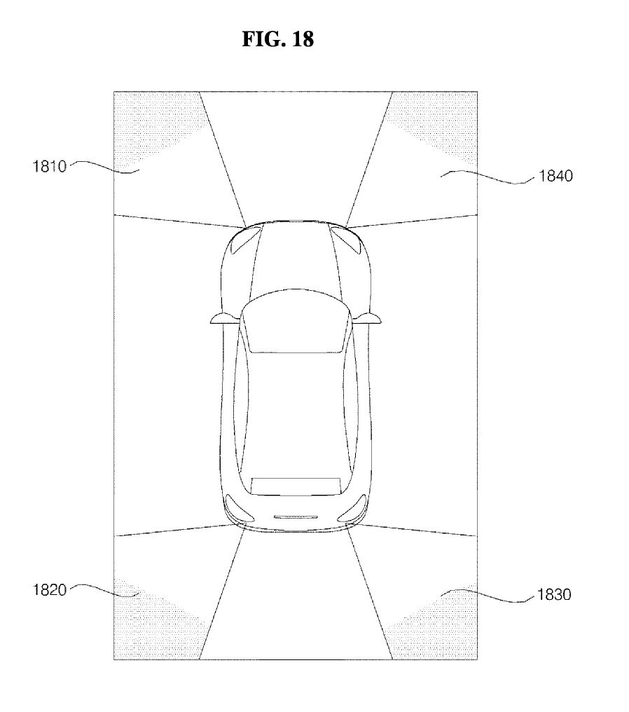

FIGS. 18, 19, 20A, 20B, 21A, 21B, and 21C are diagrams illustrating the operation of generating an around view image by combining a plurality of images according to an exemplary embodiment of the present disclosure.

FIG. 18 illustrates a case where an object is not detected in a plurality of images according to an exemplary embodiment of the present disclosure.

Referring to FIG. 18, when the number of cameras is four, four overlap areas 1810, 1820, 1830, and 1840 are generated. When an object is not detected in the plurality of images, the controller 180 performs blending processing on all of the overlap areas 1810, 1820, 1830, and 1840 and combines the images. It is possible to provide a passenger of a vehicle with a natural image by performing blending processing on the overlap areas 1810, 1820, 1830, and 1840 and combining the plurality of images.

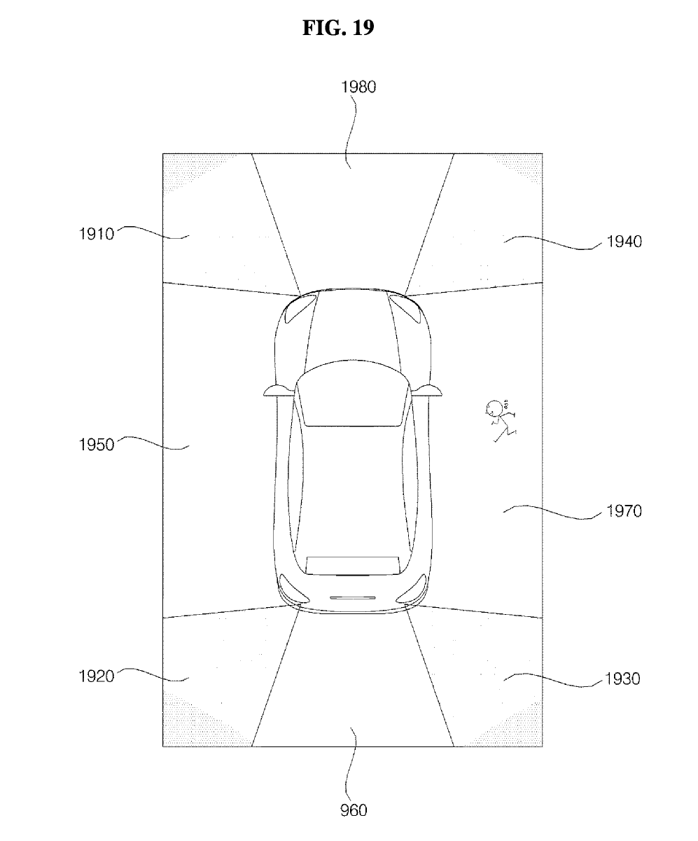

FIG. 19 illustrates a case where an object is detected in an area other than an overlap area according to an exemplary embodiment of the present disclosure.

Referring to FIG. 19, when an object is detected in areas 1950, 1960, 1970, and 1980, not overlap areas 1910, 1920, 1930, and 1940, the controller 180 performs blending processing on the overlap areas 1910, 1920, 1930, and 1940 and combines the images.

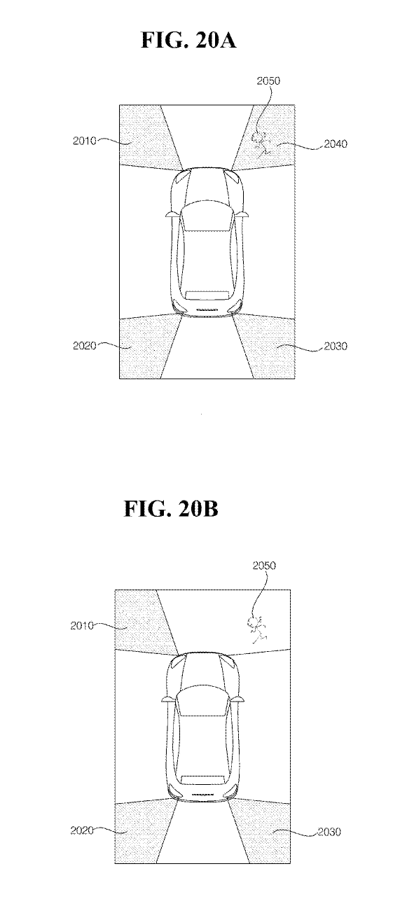

FIGS. 20A and 20B illustrate a case where an object is detected in an overlap area according to an exemplary embodiment of the present disclosure.

Referring to FIGS. 20A and 20B, when an object 2050 is detected in the overlap areas 2010, 2020, 2030, and 2040, the controller 180 processes the overlap areas based on object detection information and combines the images. Particularly, when the object is detected in the overlap areas of the plurality of images, the controller 180 compares the movement speed, movement direction, or size of the object in the plurality of images. Then, the controller 180 determines a specific image having higher reliability among the plurality of images based on a result of the comparison. The controller 180 processes the overlap area based on reliability. The controller 180 processes the overlap area only with the image having larger reliability among the plurality of images.

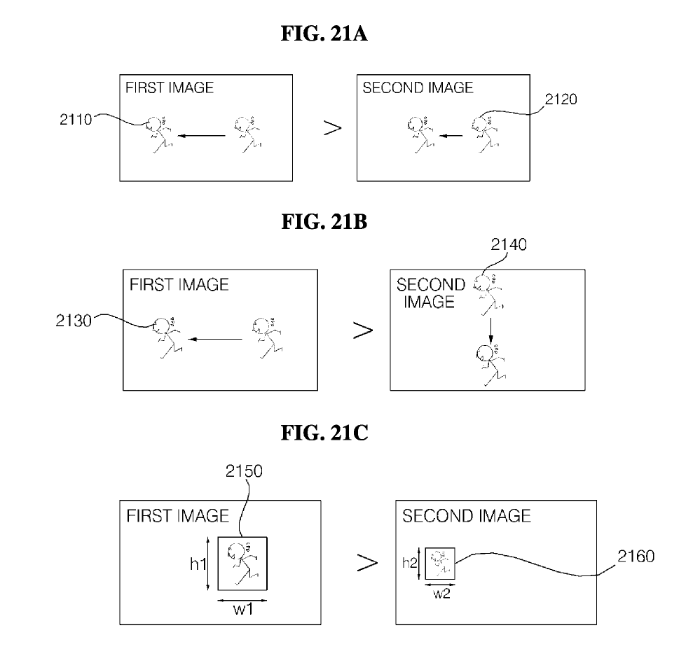

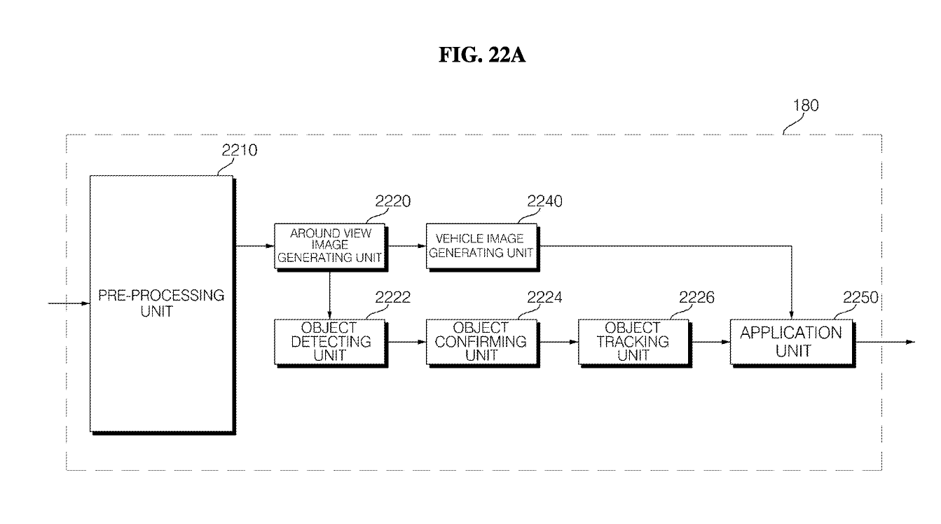

FIGS. 21A, 21B, and 21C are diagrams illustrating an operation of assigning reliability when an object is detected in an overlap area according to an exemplary embodiment of the present disclosure.

Referring to FIGS. 21A, 21B, and 21C, when an object is detected in the overlap area of the first and second images, the controller 180 compares the movement speed, movement direction, or size of the object in the first and second images. The controller 180 determines the specific image having higher reliability between the first and second images based on a result of the comparison. The controller 180 processes the overlap area based on reliability. The controller 180 processes the overlap area only with the image having the higher reliability between the first and second images.

When objects 2110 and 2120 are detected in the overlap area of the first image and the second image, the controller 180 may determine reliability based on movement speeds of the objects 2110 and 2120. As illustrated in FIG. 21A, when the movement speed of the object 2110 in the first image is larger than the movement speed of the object 2120 in the second image, the controller 180 may process the overlap area only with the first image. Here, the movement speed may be determined based on a pixel movement amount per unit time of the object in the image.

When objects 2130 and 2140 are detected in the overlap area of the first image and the second image, the controller 180 may determine reliability based on the movement direction of the objects 2130 and 2140. As illustrated in FIG. 21B, when the object 2130 moves in a horizontal direction in the first image and the object 2140 moves in a vertical direction in the second image, the controller 180 may process the overlap area only with the first image. In the vertical movement image, the object actually approaches the vehicle, so that only the size of the object is increased. However, vertical movement is disadvantageous when compared to a horizontal movement when object detection and tracking is concerned.

When objects 2150 and 2160 are detected in the overlap area of the first image and the second image, the controller 180 may determine reliability based on the size of the objects 2150 and 2160. As illustrated in FIG. 21C, when the size of the object 2150 in the first image is larger than the size of the object 2160 in the second image, the controller 180 may process the overlap area only with the first image. The size of the object may be determined based on the number of pixels occupied by the object in the image. Alternatively, the size of the object may be determined based on a size of a quadrangle surrounding the object.

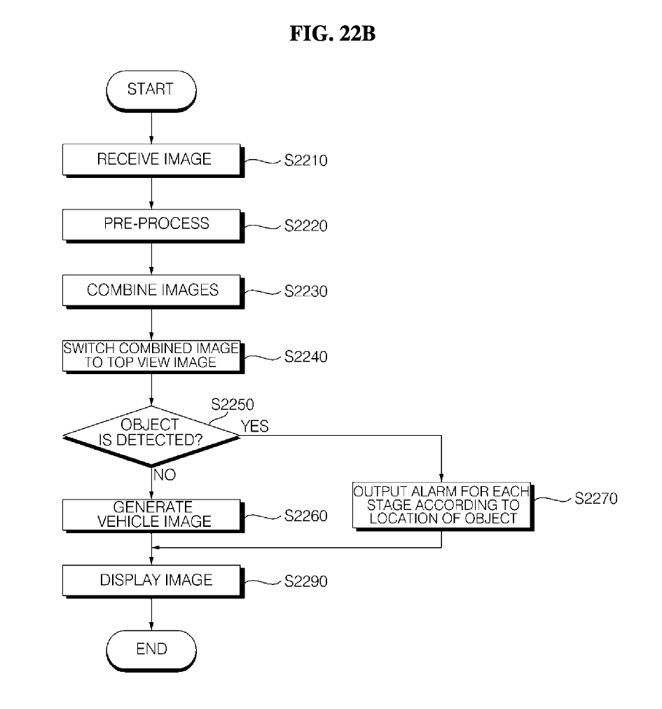

FIG. 22A is a detailed block diagram of a controller according to a fourth exemplary embodiment of the present disclosure.

Referring to FIG. 22A, the controller 180 may include a pre-processing unit 2210, an around view image generating unit 2220, a vehicle image generating unit 2240, an application unit 2250, an object detecting unit 2222, an object confirming unit 2224, and an object tracking unit 2226.

The pre-processing unit 2210 performs pre-processing on images received from one or more cameras 110a, 110b, 110c, and 110d. The pre-processing unit 2210 removes a noise of an image by using various filters or histogram equalization. The pre-processing of the image is not an essentially required process, and may be omitted according to a state of the image or an image processing purpose.

The around view image generating unit 2220 generates an around view image based on the plurality of pre-processed images. Here, the around view image may be a top-view image. The around view image generating unit 2220 combines the plurality of images pre-processed by the pre-processing unit 2210, and switches the combined image to the around view image. According to an exemplary embodiment, the around view image generating unit 2220 may also combine the plurality of images, on which the pre-processing is not performed, and switch the combined image into the around view image. In exemplary embodiments, the around view image generating unit 2220 may combine the plurality of images by using a look up table (LUT), and switch the combined image into the around view image. The LUT is a table storing information corresponding to the relationship between one pixel of the combined image and a specific pixel of the four original images.

In exemplary embodiments, the around view image generating unit 2220 generates the around view image based on a first image from the left camera 110a, a second image from a rear camera 110b, a third image from the right camera 110c, and a fourth image from the front camera 110d. In this case, the around view image generating unit 2220 may perform blending processing on each of an overlap area between the first image and the second image, an overlap area between the second image and the third image, an overlap area between the third image and the fourth image, and an overlap image between the fourth image and the first image. The around view image generating unit 2220 may generate a boundary line at each of a boundary between the first image and the second image, a boundary between the second image and the third image, a boundary between the third image and the fourth image, and a boundary between the fourth image and the first image.

The vehicle image generating unit 2240 overlays a virtual vehicle image on the around view image. That is, since the around view image is generated based on the obtained image around the vehicle through one or more cameras mounted in the vehicle 10, the around view image does not include the image of the vehicle 10. The virtual vehicle image may be provided through the vehicle image generating unit 2240, thereby enabling a passenger to intuitively recognize the around view image.

The object detecting unit 2222 may detect an object based on the around view image. Here, the object may have a concept including a pedestrian, an obstacle, a surrounding vehicle, and the like. The around view image displayed through the display device 200 may correspond to a partial area of the original images obtained through one or more cameras 110a, 110b, 110c, and 110d. The object detecting unit 2222 may include the image displayed on the display device 200, and detect the object based on the all of the original images.

The object confirming unit 2224 compares the detected object with an object stored in the first memory 160, classifies, and confirms the object.

The object tracking unit 2226 tracks the detected object. In exemplary embodiments, the object tracking unit 2226 may sequentially confirm the object within the obtained images, calculate a movement or a movement vector of the confirmed object, and track a movement of the corresponding object based on the calculated movement or movement vector.

The application unit 2250 executes various applications based on the around view image. In exemplary embodiments, the application unit 2250 may detect the object based on the around view image. Otherwise, the application unit 2250 may generate a virtual parking line in the around view image. Otherwise, the application unit 2250 may provide a predicted route of the vehicle based on the around view image. The performance of the application is not an essentially required process, and may be omitted according to a state of the image or an image processing purpose.

The application unit 2250 may perform an application operation corresponding to the detection of the object or the tracking of the object. In exemplary embodiments, the application unit 2250 may divide the plurality of images received from one or more cameras 110a, 110b, 110c, and 110d or the around view image into a plurality of areas, and determine a located area of the object in the plurality of images. In exemplary embodiments, when movement of the detected object from an area corresponding to the first image obtained through the first camera 110a to an area corresponding to the second image obtained through the second camera 110b is detected, the application unit 2250 may set an area of interest for detecting the object in the second image. Here, the application unit 2250 may detect the object in the area of interest with a top priority.

The application unit 2250 may overlay and display an image corresponding to the detected object on the around view image. The application unit 2250 may overlay and display an image corresponding to the tracked object on the around view image.

FIG. 22B is a flowchart illustrating the operation of a vehicle according to the fourth exemplary embodiment of the present disclosure.

Referring to FIG. 22B, the controller 180 receives an image from each of one or more cameras 110a, 110b, 110c, and 110d (52210).

The controller 180 performs pre-processing on each of the plurality of received images (S2220). Next, the controller 180 combines the plurality of pre-processed images (S2230), switches the combined image to a top view image (S2240), and generates an around view image. According to an exemplary embodiment, the controller 180 may also combine the plurality of images, on which the pre-processing is not performed, and switch the combined image into the around view image. In exemplary embodiments, the controller 180 may combine the plurality of images by using a look up table (LUT), and switch the combined image into the around view image. The LUT is a table storing information corresponding to the relationship between one pixel of the combined image and a specific pixel of the four original images.

In a state where the around view image is generated, the controller 180 may detect an object based on the around view image. The around view image displayed through the display device 200 may correspond to a partial area of the original images obtained through one or more cameras 110a, 110b, 110c, and 110d. The controller 180 may include the image displayed on the display device 200, and detect the object based on the all of the original images (S2250).

When a predetermined object is detected, the controller 180 outputs an alarm for each stage through the alarm unit 130 based on a location of the detected object (S2270). In exemplary embodiments, the controller 180 may divide the plurality of images received from one or more cameras 110a, 110b, 110c, and 110d or the around view image into a plurality of areas, and determine a located area of the object in the plurality of images. When the object is located in the first area, the controller 180 may control a first sound to be output. When the object is located in the second area, the controller 180 may control a second sound be output. When the object is located in the third area, the controller 180 may control a third sound to be output.

When the predetermined object is not detected, the controller 180 generates a virtual vehicle image on the around view image (S2260). Particularly, the controller 180 overlays the virtual vehicle image on the around view image.

Next, the controller 180 transmits compressed data to the display device 200 and displays the around view image (S2290).

The controller 180 may overlay and display an image corresponding to the detected object on the around view image. The controller 180 may overlay and display an image corresponding to the tracked object on the around view image.

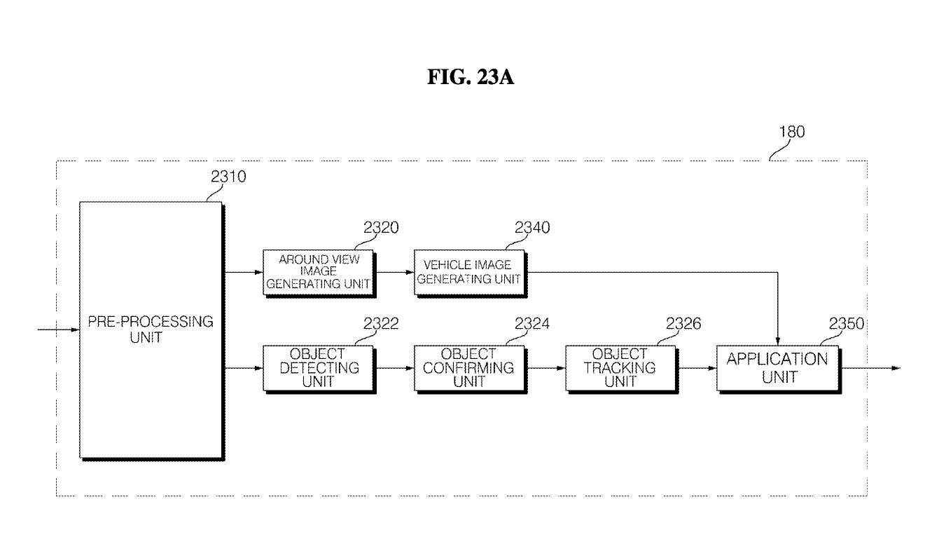

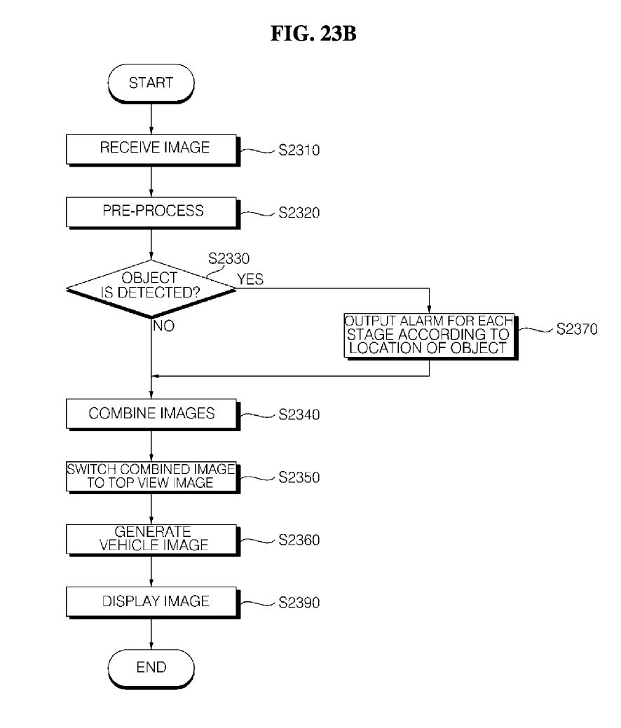

FIG. 23A is a detailed block diagram of a controller and a processor according to a fifth exemplary embodiment of the present disclosure.

The fifth exemplary embodiment is different from the fourth exemplary embodiment with respect to performance order. Hereinafter, a difference between the fifth exemplary embodiment and the fourth exemplary embodiment will be mainly described with reference to FIG. 7A.

The pre-processing unit 310 performs pre-processing on images received from one or more cameras 110a, 110b, 110c, and 110d. Then, the around view image generating unit 2320 generates an around view image based on the plurality of pre-processed images. The vehicle image generating unit 2340 overlays a virtual vehicle image on the around view image.

The object detecting unit 2322 may detect an object based on the pre-processed image. The object confirming unit 2324 compares the detected object with an object stored in the first memory 160, and classifies and confirms the object. The object tracking unit 2326 tracks the detected object. The application unit 2350 executes various applications based on the around view image. Further, the application unit 2350 performs various applications based on the detected, confirmed, and tracked object.

FIG. 23B is a flowchart illustrating the operation of a vehicle according to the fifth exemplary embodiment of the present disclosure.

The fifth exemplary embodiment is different from the first exemplary embodiment with respect to performance order. Hereinafter, a difference between the fifth exemplary embodiment and the first exemplary embodiment will be mainly described with reference to FIG. 7B.

The controller 180 receives an image from each of one or more cameras 110a, 110b, 110c, and 110d (S2310).

The controller 180 performs pre-processing on each of the plurality of received images (S2320).

Next, the controller 180 may detect an object based on the pre-processed images (S2330). The around view image displayed through the display device 200 may correspond to a partial area of the original images obtained through one or more cameras 110a, 110b, 110c, and 110d. The controller 180 may include the image displayed on the display device 200, and detect the object based on the all of the original images.

When a predetermined object is detected, the controller 180 outputs an alarm for each stage through the alarm unit 130 based on a location of the detected object (S2370). Next, the controller 180 combines the plurality of pre-processed images (S2340), switches the combined image to a top view image (S2350), and generates an around view image.

When the predetermined object is not detected, the controller 180 combines the plurality of pre-processed images (S2340), switches the combined image to a top view image (S2350), and generates an around view image. According to an exemplary embodiment, the controller 180 may also combine the plurality of images, on which the pre-processing is not performed, and switch the combined image into the around view image. In exemplary embodiments, the controller 180 may combine the plurality of images by using a look up table (LUT), and switch the combined image into the around view image. The LUT is a table storing information corresponding to the relationship between one pixel of the combined image and a specific pixel of the four original images.

When the predetermined object is not detected, the controller 180 generates a virtual vehicle image on the around view image (S2360). Particularly, the controller 180 overlays the virtual vehicle image on the around view image.

Next, the controller 180 transmits compressed data to the display device 200 and displays the around view image (S2390).

The controller 180 may overlay and display an image corresponding to the detected object on the around view image. The controller 180 may overlay and display an image corresponding to the tracked object on the around view image.

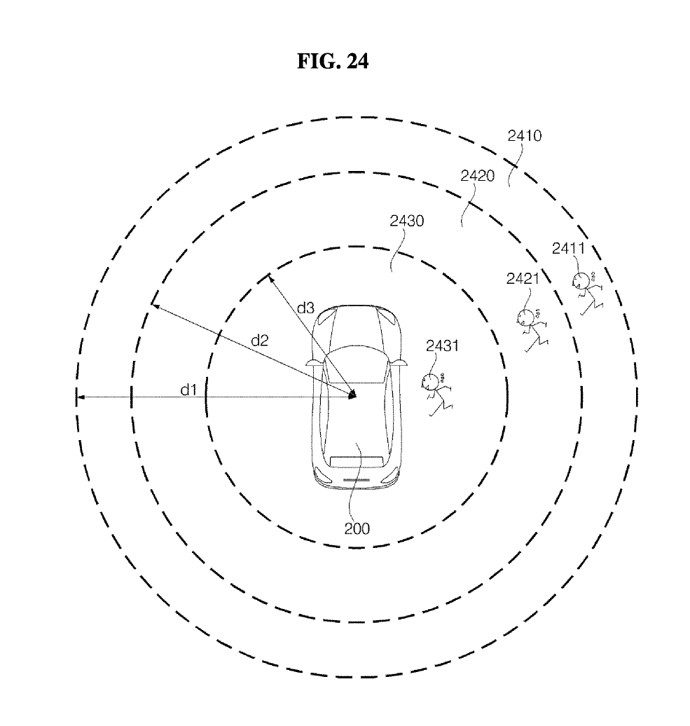

FIG. 24 is a conceptual diagram illustrating a division of an image into a plurality of areas and an object detected in the plurality of areas according to an exemplary embodiment of the present disclosure.

Referring to FIG. 24, the controller 180 detects an object based on a first image received from the first camera 110a, a second image received from the second camera 110b, a third image received from the third camera 110c, and a fourth mage received from the fourth camera 110d. In this case, the controller 180 may set an area between a first distance d1 and a second distance d2 based on the vehicle 10 as a first area 2410. The controller 180 may set an area between the second distance d2 and a third distance d3 based on the vehicle 10 as a second area 2420. The controller 180 may set an area within the third distance d3 based on the vehicle 10 as a third area 2430.

When it is determined an object 2411 is located in the first area 2410, the controller 180 may control a first alarm to be output by transmitting a first signal to the alarm unit 130. When it is determined an object 2421 is located in the second area 2420, the controller 180 may control a second alarm to be output by transmitting a second signal to the alarm unit 130. When it is determined an object 2431 is located in the third area 2430, the controller 180 may control a third alarm to be output by transmitting a third signal to the alarm unit 130. As described above, the controller 180 may control the alarm for each stage to be output based on the location of the object.

The method of detecting a distance to an object based on an image may use a publicly known technique.

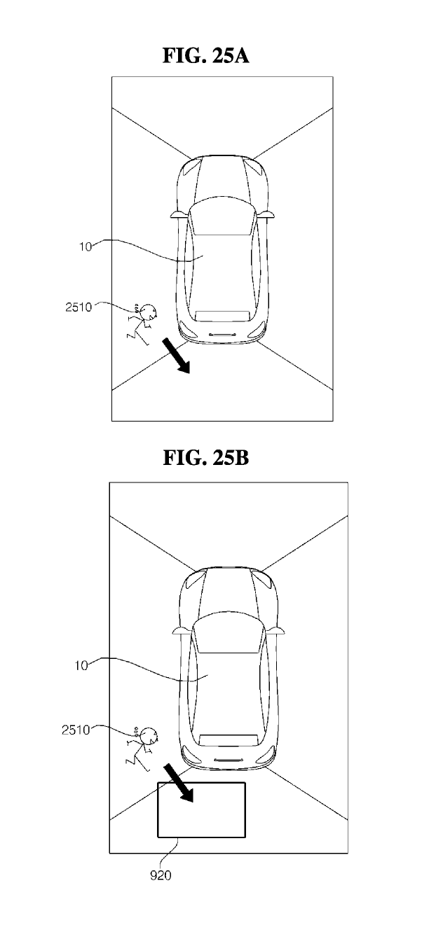

FIGS. 25A and 25B are concept diagrams illustrating an operation for the tracking an object according to an exemplary embodiment of the present disclosure.

Referring to FIGS. 25A and 25B, an object 2510 may move from the first area to the second area. In this case, the first area may be an area corresponding to the first image obtained by the first camera 110a. The second may be an area corresponding to the second image obtained by the second camera 110b. That is, the object 2510 moves from a field of view (FOV) of the first camera 110a to a FOV of the second camera 110b.

When the object 2510 is located at a left side of the vehicle 10, the controller 180 may detect, confirm, and track the object 2510 in the first image. When the object 2510 moves to a rear side of the vehicle 10, the controller 180 tracks a movement of the object 2510. The controller 180 may predict a predicted movement route of the object 2510 through the tracking of the object 2510. The controller 180 may set an area of interest 920 for detecting an object in the second image through the predicted movement route. The controller 180 may detect the object in the area of interest 920 with a top priority. As described above, it is possible to improve accuracy and a speed of detection when the object 2510 is detected through the second camera by setting the area of interest 920.

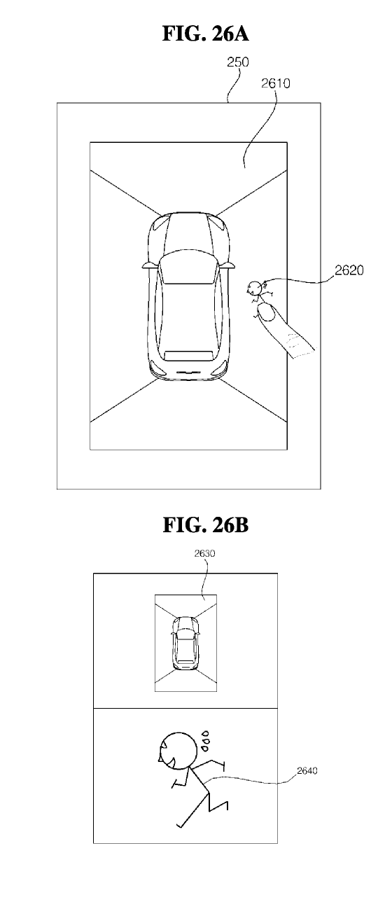

FIGS. 26A and 26B are example diagrams illustrating an around view image displayed on the display device according to an exemplary embodiment of the present invention.

As illustrated in FIG. 26A, the controller 180 may display an around view image 2610 through the display unit 250 included in the display device 200. The controller 180 may overlay and display an image 2620 corresponding to the detected object on the around view image. The controller 180 may overlay and display an image 2620 corresponding to the tracked object on the around view image.

When a touch input for an area, in which the image 2620 corresponding to the object is displayed, is received, the controller 180 may display an image that is a basis for detecting the object on the display unit 250 as illustrated in FIG. 26B. In exemplary embodiments, the controller 180 may decrease the around view image and display the decreased around view image on the first area of the display unit 25, and display the image that is the basis for detecting the object on a second area of the display unit 250. That is, the controller 180 may display a third image as it is received from the third camera 110c, in which the object is detected, on the display unit 250 as it is.

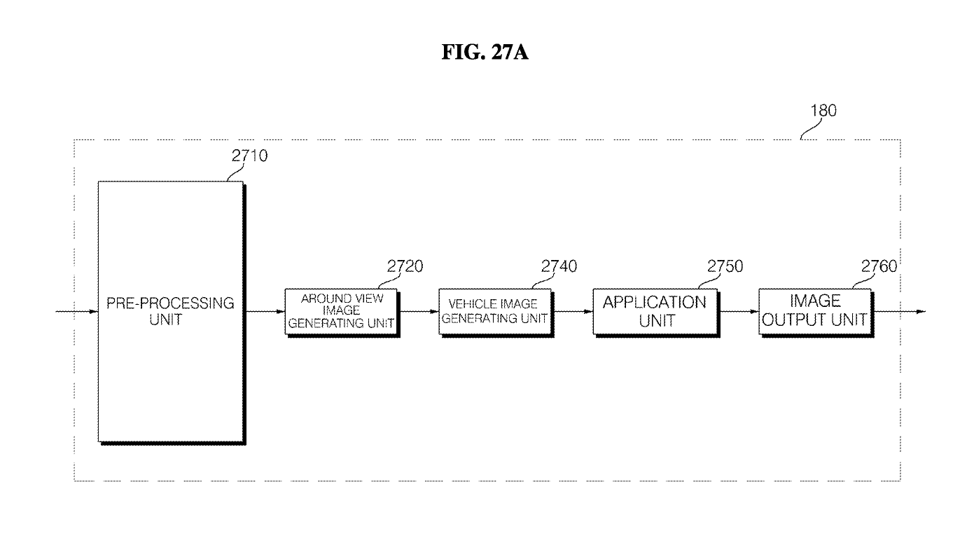

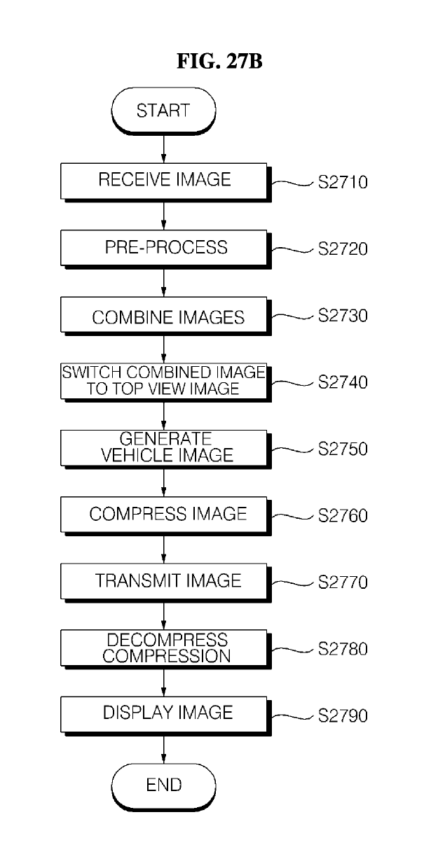

FIG. 27A is a detailed block diagram of a controller according to a sixth exemplary embodiment of the present disclosure.

Referring to FIG. 27A, the controller 180 may include a pre-processing unit 2710, an around view image generating unit 2720, a vehicle image generating unit 2740, an application unit 2750, and an image compressing unit 2760.

The pre-processing unit 2710 performs pre-processing on images received from one or more cameras 110a, 110b, 110c, and 110d. The pre-processing unit 2710 removes a noise of an image by using various filters or histogram equalization. The pre-processing of the image is not an essential process, and may be omitted according to a state of the image or an image processing purpose.

The around view image generating unit 2720 generates an around view image based on the plurality of pre-processed images. Here, the around view image may be a top-view image. The around view image generating unit 2720 combines the plurality of images pre-processed by the pre-processing unit 2710, and switches the combined image to the around view image. According to an exemplary embodiment, the around view image generating unit 2720 may also combine the plurality of images, on which the pre-processing is not performed, and switch the combined image into the around view image. In exemplary embodiments, the around view image generating unit 2720 may combine the plurality of images by using a look up table (LUT), and switch the combined image into the around view image. The LUT is a table storing information corresponding to the relationship between one pixel of the combined image and a specific pixel of the four original images.

In exemplary embodiments, the around view image generating unit 2720 generates the around view image based on a first image from the left camera 110a, a second image from a rear camera 110b, a third image from the right camera 110c, and a fourth image from the front camera 110d. In this case, the around view image generating unit 2720 may perform blending processing on each of an overlap area between the first image and the second image, an overlap area between the second image and the third image, an overlap area between the third image and the fourth image, and an overlap image between the fourth image and the first image. The around view image generating unit 2720 may generate a boundary line at each of a boundary between the first image and the second image, a boundary between the second image and the third image, a boundary between the third image and the fourth image, and a boundary between the fourth image and the first image.

The vehicle image generating unit 2740 overlays a virtual vehicle image on the around view image. That is, since the around view image is generated based on the obtained image around the vehicle through one or more cameras mounted in the vehicle 10, the around view image does not include the image of the vehicle 10. The virtual vehicle image may be provided through the vehicle image generating unit 2740, thereby enabling a passenger to intuitively recognize the around view image.

The application unit 2750 executes various applications based on the around view image. In exemplary embodiments, the application unit 2750 may detect the object based on the around view image. Otherwise, the application unit 2750 may generate a virtual parking line in the around view image. Alternatively, the application unit 2750 may provide a predicted route of the vehicle based on the around view image. The performance of the application is not an essentially required process, and may be omitted according to a state of the image or an image processing purpose.

The image compressing unit 2760 compresses the around view image. According to an exemplary embodiment, the image compressing unit 2760 may compress the around view image before the virtual vehicle image is overlaid. According to another exemplary embodiment, the image compressing unit 2760 may compress the around view image after the virtual vehicle image is overlaid. According to another exemplary embodiment, the image compressing unit 2760 may compress the around view image before various applications are executed. According to another exemplary embodiment, the image compressing unit 2760 may compress the around view image after various applications are executed.

The image compressing unit 2760 may perform compression by using any one of the simple compression techniques, interpolative techniques, predictive techniques, transform coding techniques, statistical coding techniques, loss compression techniques, and lossless compression techniques.

The around view image compressed by the image compressing unit 2760 may be a still image or a moving image. The image compressing unit 2760 may compress the around view image based on a standard. When the around view image is a still image, the image compressing unit 2760 may compress the around view image by any one method among a joint photographic experts group (JPEG) and graphics interchange format (GIP). When the around view image is a moving image, the image compressing unit 2760 may compress the around view image by any one method among MJPEG, Motion JPEG 2000, MPEG-1, MPEG-2, MPEG-4, MPEG-H Part2/HEVC, H.120, H.261, H.262, H.263, H.264, H.265, H.HEVC, AVS, Bink, CineForm, Cinepak, Dirac, DV, Indeo, Microsoft Video 1, OMS Video, Pixlet, ProRes 422, RealVideo, RTVideo, SheerVideo, Smacker, Sorenson Video, Spark, Theora, Uncompressed, VC-1, VC-2, VC-3, VP3, VP6, VP7, VP8, VP9, WMV, and XEB. The scope of the present disclosure is not limited to the aforementioned method, and a method capable of compressing a still image or a moving image, other than each aforementioned method may be included in the scope of the present disclosure.

The controller 180 may further include a scaling unit (not illustrated). The scaling unit (not illustrated) scales high-quality images received from one or more cameras 110a, 110b, 110c, and 110d to a low image quality. When a scaling control command is received by a user's input from the display device 200, the scaling unit (not illustrated) performs scaling on an original image. When a load of the Ethernet communication network is equal to or smaller than a reference value, the scaling unit (not illustrated) performs scaling on the original image. Then, the image compressing unit 2760 may compress the scaled image. According to an exemplary embodiment, the scaling unit (not illustrated) may be disposed at any one place among a place before the pre-processing unit 2710, a space between the pre-processing unit 2710 and the around view image generating unit 2720, a space between the around view image generating unit 2720 and the vehicle image generating unit 2740, a space between the vehicle image generating unit 2740 and the application unit 2750, and a space between the application unit 2750 and the image compressing unit 2760.

FIG. 27B is a flowchart for describing an operation of a vehicle according to the sixth exemplary embodiment of the present disclosure.

Referring to FIG. 27B, the controller 180 receives an image from each of one or more cameras 110a, 110b, 110c, and 110d (S2710).

The controller 180 performs pre-processing on each of the plurality of received images (S2720). Next, the controller 180 combines the plurality of pre-processed images (S2730), switches the combined image to a top view image (S2740), and generates an around view image. According to an exemplary embodiment, the around view image generating unit 320 may also combine the plurality of images, on which the pre-processing is not performed, and switch the combined image into the around view image. In exemplary embodiments, the around view image generating unit 320 may combine the plurality of images by using a look up table (LUT), and switch the combined image into the around view image. The LUT is a table storing information corresponding to the relationship between one pixel of the combined image and a specific pixel of the four original images.

Then, the controller 180 generates a virtual vehicle image on the around view image (S2750). Particularly, the controller 180 overlays the virtual vehicle image on the around view image.

Then, the controller 180 compresses the around view image (S2760). According to an exemplary embodiment, the image compressing unit 360 may compress the around view image before the virtual vehicle image is overlaid. According to an exemplary embodiment, the image compressing unit 360 may compress the around view image after the virtual vehicle image is overlaid.

Next, the controller 180 transmits compressed data to the display device 200 (S2770).

Next, the processor 280 decompresses the compressed data (S2780). Here, the processor 280 may include a compression decompressing unit 390. The compression decompressing unit 390 decompresses the compressed data received from the image compressing unit 360. In this case, the compression decompressing unit 390 decompresses the compressed data through a reverse process of a compression process performed by the image compressing unit 360.

Next, the processor 280 displays an image based on the decompressed data (S2790).

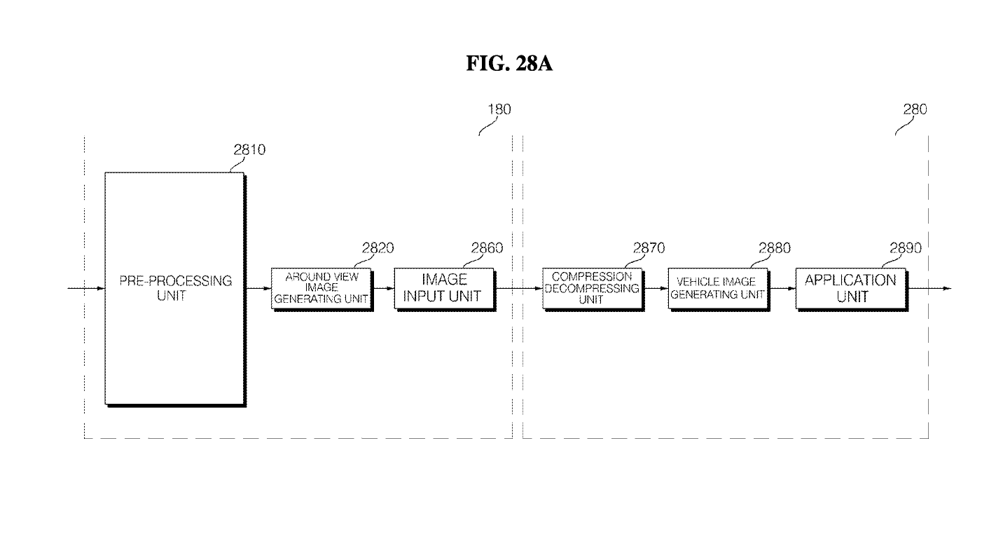

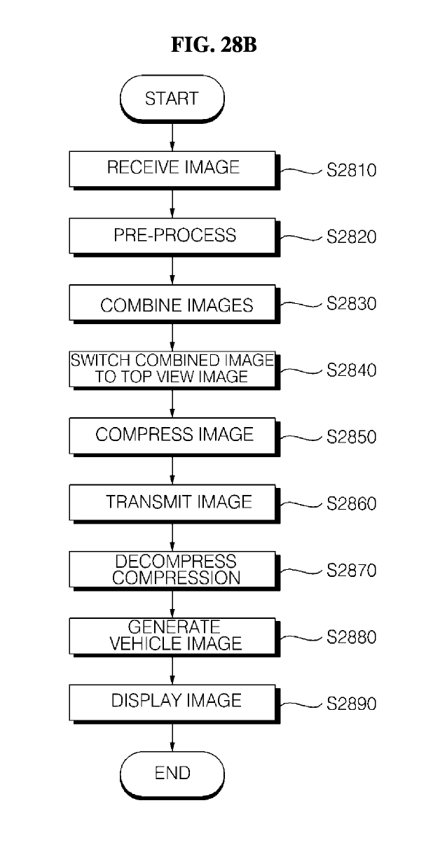

FIG. 28A is a detailed block diagram of a controller and a processor according to a seventh exemplary embodiment of the present disclosure.

The seventh exemplary embodiment is different from the sixth exemplary embodiment with respect to performance order. Hereinafter, a difference between the seventh exemplary embodiment and the sixth exemplary embodiment will be mainly described with reference to FIG. 7A.

The controller 180 may include a pre-processing unit 2810, an around view image generating unit 2820, and an image compressing unit 2860. Further, the processor 280 may include the compression decompressing unit 2870, a vehicle image generating unit 2880, and an application unit 2890.

The pre-processing unit 2810 performs pre-processing on images received from one or more cameras 110a, 110b, 110c, and 110d. Then, the around view image generating unit 2820 generates an around view image based on the plurality of pre-processed images. The image compressing unit 2860 compresses the around view image.

The compression decompressing unit 2870 decompresses the compressed data received from the image compressing unit 2860. In this case, the compression decompressing unit 2870 decompresses the compressed data through a reverse process of a compression process performed by the image compressing unit 2860.

The vehicle image generating unit 2880 overlays a virtual vehicle image on the decompressed around view image. The application unit 2890 executes various applications based on the around view image.

FIG. 28B is a flowchart for describing an operation of a vehicle according to the seventh exemplary embodiment of the present disclosure.

The seventh exemplary embodiment is different from the sixth exemplary embodiment with respect to performance order. Hereinafter, a difference between the seventh exemplary embodiment and the sixth exemplary embodiment will be mainly described with reference to FIG. 7B.

The controller 180 receives an image from each of one or more cameras 110a, 110b, 110c, and 110d (S2810).

The controller 180 performs pre-processing on each of the plurality of received images (S2820). Next, the controller 180 combines the plurality of pre-processed images (S2830), switches the combined image to a top view image (S2840), and generates an around view image. According to an exemplary embodiment, the around view image generating unit 320 may also combine the plurality of images, on which the pre-processing is not performed, and switch the combined image into the around view image. In exemplary embodiments, the around view image generating unit 320 may combine the plurality of images by using a look up table (LUT), and switch the combined image into the around view image. The LUT is a table storing information corresponding to the relationship between one pixel of the combined image and a specific pixel of the four original images.

Then, the controller 180 compresses the around view image (S2850). According to an exemplary embodiment, the image compressing unit 360 may compress the around view image before the virtual vehicle image is overlaid. According to an exemplary embodiment, the image compressing unit 360 may compress the around view image after the virtual vehicle image is overlaid.

Next, the controller 180 transmits compressed data to the display device 200 (S2860).

Next, the processor 280 decompresses the compressed data (S2870). Here, the processor 280 may include the compression decompressing unit 390. The compression decompressing unit 390 decompresses the compressed data received from the image compressing unit 360. In this case, the compression decompressing unit 390 decompresses the compressed data through a reverse process of a compression process performed by the image compressing unit 360.

Then, the processor 280 generates a virtual vehicle image on the around view image (S2880). Particularly, the processor 280 overlays the virtual vehicle image on the around view image.

Next, the processor 280 displays an image based on the decompressed data (S2890).

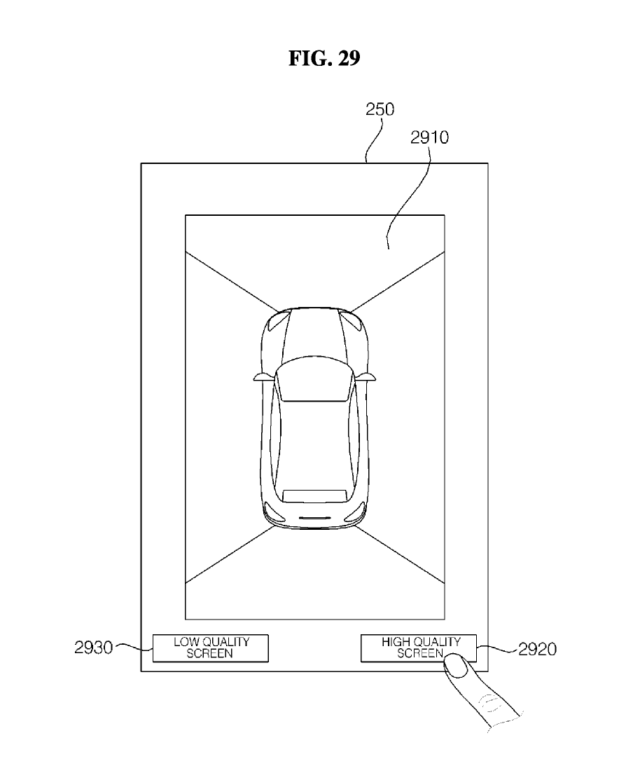

FIG. 29 is an example diagram illustrating an around view image displayed on the display device according to an exemplary embodiment of the present disclosure.

Referring to FIG. 29, the processor 280 displays an around view image 2910 on the display unit 250. Here, the display unit 250 may be formed of a touch screen. The processor 280 may adjust resolution of the around view image in response to a user's input received through the display unit 250. When a touch input for a high quality screen icon 2920 is received, the processor 280 may change the around view image displayed on the display unit 250 to have a high quality. In this case, the controller 180 may compress the plurality of high quality images received to one or more cameras 110a, 110b, 110c, and 110d as it is.

When a touch input for a low quality screen icon 2930 is received, the processor 280 may change the around view image displayed on the display unit 250 to have low quality. In this case, the controller 180 may perform scaling on the plurality of images received to one or more cameras 110a, 110b, 110c, and 110d, decreases the amount of data, and compress the plurality of images.

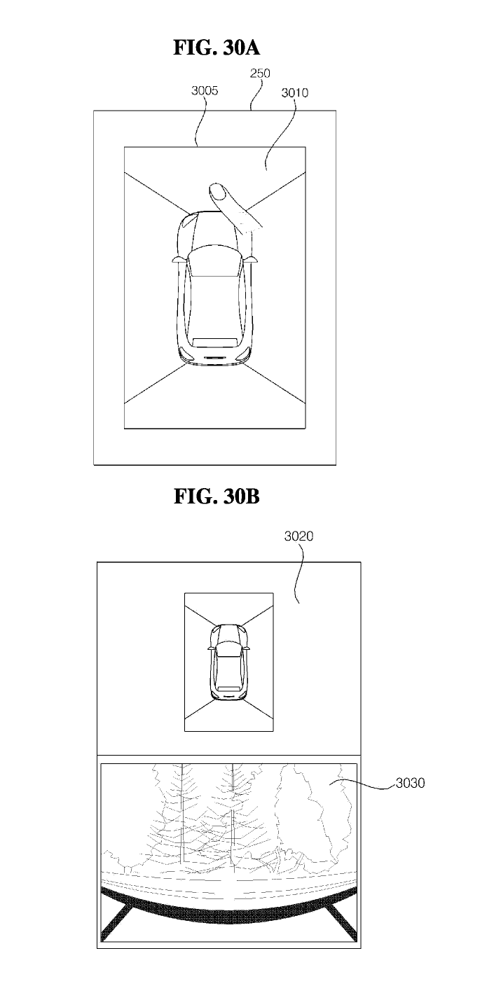

FIGS. 30A and 30B are example diagrams illustrating an operation of displaying only a predetermined area in an around view image with a high quality according to an exemplary embodiment of the present disclosure.

Referring to FIG. 30A, the processor 280 displays an around view image 3005 on the display unit 250. In a state where the around view image 3005 is displayed, the processor 280 receives a touch input for a first area 3010. Here, the first area 3010 may be an area corresponding to the fourth image obtained through the fourth camera 110d.

Referring to FIG. 30B, when a touch input for the first area 3010 is received, the processor 280 decreases the around view image and displays the decreased around view image on a predetermined area 3020 of the display unit 250. The processor 280 displays an original image of the fourth image obtained through the fourth camera 110d on a predetermined area 3030 of the display unit 250 as it is. The processor 280 displays the fourth image with a high quality.

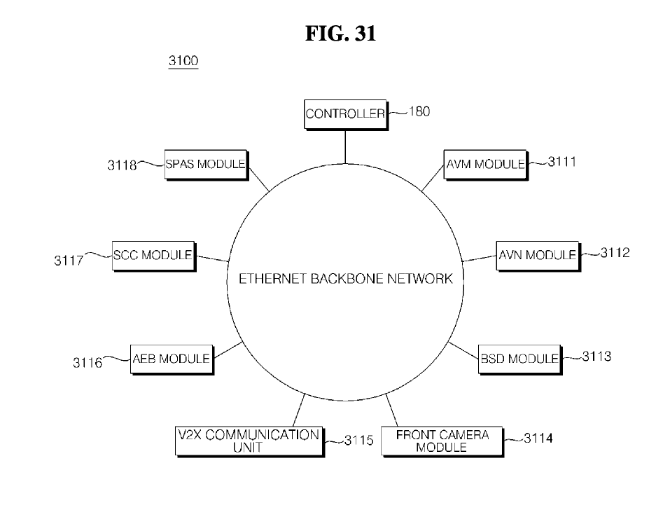

FIG. 31 is a diagram illustrating an Ethernet backbone network according to an exemplary embodiment of the present disclosure.

The vehicle 10 may include a plurality of sensor units, a plurality of input units, one or more controllers 180, a plurality of output units, and an Ethernet backbone network.

The plurality of sensor units may include a camera, an ultrasonic sensor, radar, a LIDAR, a global positioning system (GPS), a speed detecting sensor, an inclination detecting sensor, a battery sensor, a fuel sensor, a steering sensor, a temperature sensor, a humidity sensor, a yaw sensor, a gyro sensor, and the like.

The plurality of input units may include a steering wheel, an acceleration pedal, a brake pedal, various buttons, a touch pad, and the like.

The plurality of output units may include an air conditioning driving unit, a window driving unit, a lamp driving unit, a steering driving unit, a brake driving unit, an airbag driving unit, a power source driving unit, a suspension driving unit, an audio video navigation (AVN) device, and an audio output unit.

One or more controllers 180 may be a concept including an electronic control unit (ECU).

Next, referring to FIG. 31, the vehicle 10 may include an Ethernet backbone network 3100 according to the first exemplary embodiment.

The Ethernet backbone network 3100 is a network establishing a ring network through an Ethernet protocol, so that the plurality of sensor units, the plurality of input units, the controller 180, and the plurality of output units exchange data with one another.

The Ethernet is a network technology, and defines signal wiring in a physical layer of an OSI model, and a form of a media access control (MAC) packet and a protocol in a data link layer.

The Ethernet may use a carrier sense multiple access with collision detection (CSMA/CD). In exemplary embodiments, a module desiring to use the Ethernet backbone network may detect whether data currently flows on the Ethernet backbone network. Further, the module desiring to use the Ethernet backbone network may determine whether currently flowing data is equal to or larger than a reference value. Here, the reference value may mean a threshold value enabling data communication to be smoothly performed. When the data currently flowing on the Ethernet backbone network is equal to or larger than the reference value, the module does not transmit the data and stands by. When the data flowing on the Ethernet backbone network is smaller than the reference value, the module immediately starts to transmit the data.

When several modules simultaneously start to transmit the data, a collision is generated, and the data flowing on the Ethernet backbone network is equal to or larger than the reference value, the modules continuously transmit the data for a minimum packet time to enable other modules to detect the collision. Then, the modules stand by for a predetermined time, and then detect a carrier wave again, and when the data flowing on the Ethernet backbone network is smaller than the reference value, the modules may start to transmit the data again.

The Ethernet backbone network may include an Ethernet switch. The Ethernet switch may support a full duplex communication method, and improve a data exchange speed on the Ethernet backbone network. The Ethernet switch may be operated so as to transmit data only to a module requiring the data. That is, the Ethernet switch may store a unique MAC address of each module, and determine a kind of data and a module, to which the data needs to be transmitted, through the MAC address.

The ring network, which is one method of the network topology, is a network configuration method, in which each node is connected with two nodes at both sides thereof to perform communication through one generally continuous path, such as a ring. Data moves from a node to a node, and each node may process a packet. Each module may be connected to each node to exchange data.

The aforementioned module may be a concept including any one of the plurality of sensor units, the plurality of input units, the controller 10, and the plurality of output units.

As described above, when the respective modules are connected through the Ethernet backbone network, the respective modules may exchange data. In exemplary embodiments, when the AVM module transmits image data through the Ethernet backbone network 3100 in order to output an image to an AVN module, a module other than the AVN module may also receive the image data loaded on the Ethernet backbone network 3100. In exemplary embodiments, an image obtained by the AVM module may be utilized for a black box, other than an AVM screen to be output.

In exemplary embodiments, the controller 180, an AVM module 3111, an AVN module 3112, a blind spot detection (BSD) module 3113, a front camera module 3114, a V2X communication unit 3115, an auto emergency brake (AEB) module 3116, a smart cruise control (SCC) module 3117, and a smart parking assist system (SPAS) module 3118 may be connected to each node of the Ethernet backbone network 3100. Each module may transmit and receive data through the Ethernet backbone network 3100.

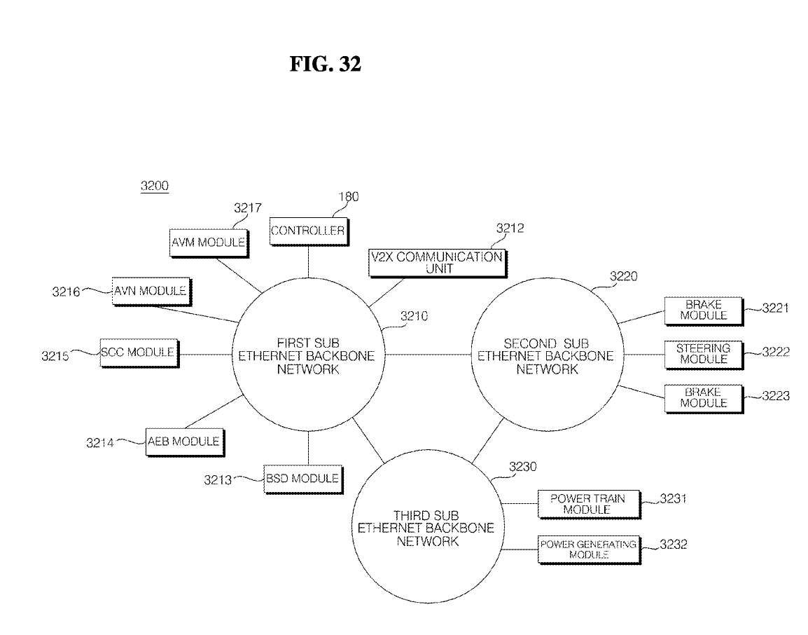

FIG. 32 is a diagram illustrating an Ethernet Backbone network according to an exemplary embodiment of the present disclosure.

Referring to FIG. 32, an Ethernet backbone network 3210 according to a second exemplary embodiment may include a plurality of sub Ethernet backbone networks. Here, the plurality of sub Ethernet backbone networks may establish a plurality of ring networks for communication for each function of each of the plurality of sensor units, the plurality of input units, the controller 180, and the plurality of output units, which are divided based on a function. The plurality of sub Ethernet backbone networks may be connected with each other.

The Ethernet backbone network 3200 may include a first sub Ethernet backbone network 3210, a second sub Ethernet backbone network 3220, and a third sub Ethernet backbone network 3230. In the present exemplary embodiment, the Ethernet backbone network 3200 includes the first to third sub Ethernet backbone networks, but is not limited thereto, and may include more or less sub Ethernet backbone networks.

The controller 180, a V2X communication unit 3212, a BSD module 3213, an AEB module 3214, an SCC module 3215, an AVN module 3216, and an AVM module 3217 may be connected to each node of the first sub Ethernet backbone network 3210. Each module may transmit and receive data through the first sub Ethernet backbone network 3210.

In exemplary embodiments, the plurality of sensor units may include one or more cameras 110a, 110b, 110c, and 110d. In this case, one or more cameras may be the cameras 110a, 110b, 110c, and 110d included in the AVM module. The plurality of output units may include the AVN module. Here, the AVN module may be the display device 200 described with reference to FIGS. 4 and 5. The controller 180, one or more cameras 110a, 110b, 110c, and 110d, and the AVN module may exchange data through the first sub Ethernet backbone network.

The first sub Ethernet backbone network 3210 may include a first Ethernet switch.

The first sub Ethernet backbone network 3210 may further include a first gateway so as to be connectable with other sub Ethernet backbone networks 3220 and 3230.

A suspension module 3221, a steering module 3222, and a brake module 3223 may be connected to each node of the second sub Ethernet backbone network 3220. Each module may transmit and receive data through the second sub Ethernet backbone network 3220.

The second sub Ethernet backbone network 3220 may include a second Ethernet switch.

The second sub Ethernet backbone network 3220 may further include a second gateway so as to be connectable with other sub Ethernet backbone networks 3210 and 3230.

A power train module 3231 and a power generating module 3232 may be connected to each node of the third sub Ethernet backbone network 3230. Each module may transmit and receive data through the third sub Ethernet backbone network 3230.

The third sub Ethernet backbone network 3230 may include a third Ethernet switch.

The third sub Ethernet backbone network 3230 may further include a third gateway so as to be connectable with other sub Ethernet backbone networks 3210 and 3220.

The Ethernet backbone network includes the plurality of sub Ethernet backbone networks, thereby decreasing loads applicable to the Ethernet backbone network.

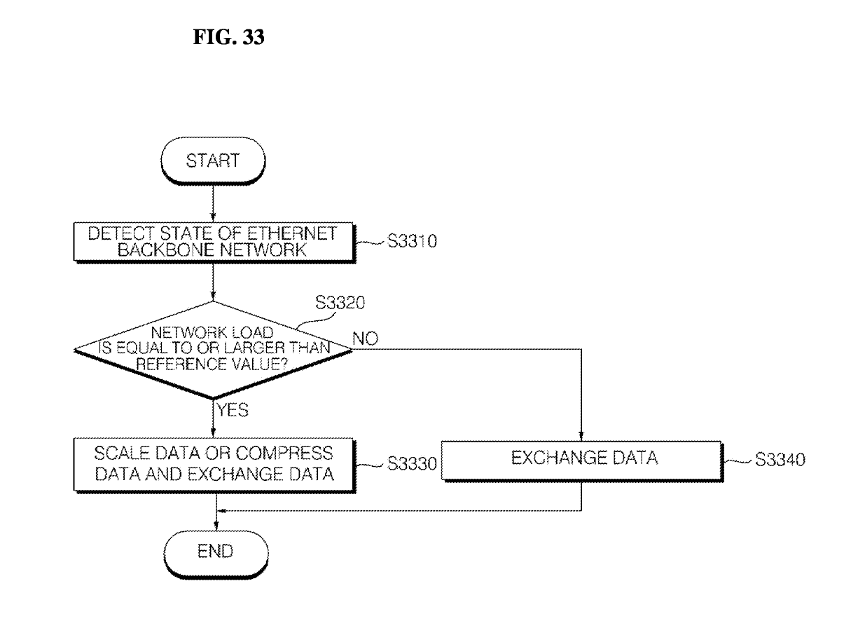

FIG. 33 is a diagram illustrating an operation when a network load is equal to or larger than a reference value according to an exemplary embodiment of the present disclosure.

Referring to FIG. 33, the controller 180 may detect states of Ethernet backbone networks 1000 and 1100 (S3310). In exemplary embodiments, the controller 180 may detect a data quantity exchanged through the Ethernet backbone networks 1000 and 1100.

The controller 180 determines whether the data exchanged through the Ethernet backbone networks 1000 and 1100 is equal to or larger than a reference value (S3320).

When the data exchanged through the Ethernet backbone networks 1000 and 1100 is equal to or larger than the reference value, the controller 180 may scale or compress data exchanged between the plurality of sensor units, the plurality of input units, and the plurality of output units and exchange the data (S3330).

In exemplary embodiments, the plurality of sensor units may include one or more cameras, and the plurality of output units may include the AVN module. When the data exchanged through the Ethernet backbone networks 1000 and 1100 is equal to or larger than the reference value, the controller 180 may scale or compress image data exchanged between one or more cameras and the AVN module and exchange the image data.

The controller 180 may perform compression by using any one of simple compression techniques, interpolative techniques, predictive techniques, transform coding techniques, statistical coding techniques, loss compression techniques, and lossless compression techniques.

The around view image compressed by the controller 180 may be a still image or a moving image. The controller 180 may compress the around view image based on a standard. When the around view image is a still image, the image compressing unit 2760 may compress the around view image by any one method among a joint photographic experts group (JPEG) method and a graphics interchange format (GIP) method. When the around view image is a moving image, the image compressing unit 2760 may compress the around view image by any suitable method. Some suitable methods include MJPEG, Motion JPEG 2000, MPEG-1, MPEG-2, MPEG-4, MPEG-H Part2/HEVC, H.120, H.261, H.262, H.263, H.264, H.265, H.HEVC, AVS, Bink, CineForm, Cinepak, Dirac, DV, Indeo, Microsoft Video 1, OMS Video, Pixlet, ProRes 422, RealVideo, RTVideo, SheerVideo, Smacker, Sorenson Video, Spark, Theora, Uncompressed, VC-1, VC-2, VC-3, VP3, VP6, VP7, VP8, VP9, WMV, and XEB. The scope of the present disclosure is not limited to the aforementioned method, and a method capable of compressing a still image or a moving image, other than each aforementioned method may be included in the scope of the present disclosure.

The controller 180 may scale high-quality images received from one or more cameras 110a, 110b, 110c, and 110d to a low image quality.

When the data exchanged through the Ethernet backbone networks 1000 and 1100 is smaller than the reference value, the controller 180 may exchange data by a normal method (S3340).

The vehicle according to exemplary embodiments of the present disclosure may variably adjust the image quality, thereby decreasing loads to the vehicle network.

In an exemplary embodiment, the vehicle efficiently exchanges or is configured to efficiently exchange large data by using the Ethernet backbone network.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A vehicle, comprising:
a display device;
one or more cameras; and
a controller configured to:
combine a plurality of images received from the one or more cameras and switch the combined image to a top view image to generate an around view image,
detect an object from at least one of the plurality of images and the around view image,
determine a weighted value of two images obtained from two cameras of the one or more cameras when an object is located in an overlapping area in views of the two cameras,
assign a weighted value to a specific image of the two images from the two cameras with the overlapping area, and
display the specific image with the assigned weighted value and the around view image on the display device.

2. The vehicle of claim 1, wherein the one or more cameras comprise:
a first camera configured to obtain an image around a left side of the vehicle;
a second camera configured to obtain an image around a rear side of the vehicle;
a third camera configured to obtain an image around a right side of the vehicle; and
a fourth camera configured to obtain an image around a front side of the vehicle.

3. The vehicle of claim 2, wherein:
when the weighted value is assigned to the specific image from the first camera, the controller displays the image around the left side of the vehicle at a left side of the around view image on the display device,
when the weighted value is assigned to the specific image from the second camera, the controller displays the image around the rear side of the vehicle at a lower side of the around view image on the display device,
when the weighted value is assigned to the specific image from the third camera, the controller displays the image around the right side of the vehicle at a right side of the around view image on the display device, and
when the weighted value is assigned to the specific image from the fourth camera, the controller displays the image around the front side of the vehicle at an upper side of the around view image on the display device.

4. The vehicle of claim 1, wherein the display device comprises a touch input unit and when the touch input unit receives a touch input for the object displayed on the specific image with the assigned weighted value, the controller enlarges the object and displays the enlarged object.

5. The vehicle of claim 1, wherein the display device comprises a touch input unit and when the touch input unit receives a touch input for the object displayed on the specific with the assigned weighted value, the controller controls the camera associated with weighted value to zoom in.

6. A vehicle, comprising:
a display device;
one or more cameras; and
a controller configured to:
combine a plurality of images received from the one or more cameras and switch the combined image to a top view image to generate an around view image,
detect an object from at least one of the plurality of images and the generated around view image,
determine a weighted value of two images obtained from two cameras of the one or more cameras based on a disturbance generated in the two cameras when the object is located in an overlapping area in views of the two cameras, and
display the around view image on the display device.

7. The vehicle of claim 6, wherein when disturbance is generated in one camera between the two cameras, the controller assigns a weighted value of 100% a specific image from the camera of the two cameras without the generated disturbance.

8. The vehicle of claim 6, wherein the disturbance is at least one of light inflow, exhaust gas generation, lens contamination, low luminance, image saturation, side mirror folding, and trunk opening.

9. The vehicle of claim 6, wherein the controller determines a weighted value through at least one of a score level method and a feature level method.

10. The vehicle of claim 9, wherein when the controller determines the weighted value through the score level method, the controller determines the weighted value by assigning an AND condition or an OR condition to the images obtained by the two cameras.

11. The vehicle of claim 9, wherein when the controller determines the weighted value through the feature level method, the controller determines the weighted value by comparing at least one of movement speeds, directions, and sizes of the object obtained in the at least one of the plurality of images and the generated around view image.

12. The vehicle of claim 11, wherein when the controller determines the weighted value based on the movement speed of the object, the controller compares the images obtained by the two cameras and assigns the weighted value to a specific image obtained by the two cameras having a larger object pixel movement amount than the other image obtained by the two cameras.

13. The vehicle of claim 11, wherein when the controller determines the weighted value based on the directions of the object, the controller compares the images obtained by the two cameras and assigns the weighted value to a specific image having a larger horizontal movement than the other image obtained by the two cameras.

14. The vehicle of claim 11, wherein when the controller determines the weighted value by comparing the sizes of the object, the controller compares the images obtained by the two cameras and assigns the weighted value to a specific image having a larger area of a virtual quadrangle surrounding the object than the other image obtained by the two cameras.

15. A vehicle, comprising:
a display device;
one or more cameras; and
a controller configured to:
receive a plurality of images related to a surrounding area of the vehicle from one or more cameras,
determine whether an object is detected from at least one of the plurality of images,
determine whether the object is located in at least one of a plurality of overlap areas of the plurality of images,
process the at least one of the plurality of overlap areas based on object detection information when the object is located in the overlap area, and
perform blending processing on the at least one of the plurality of overlap areas according to a predetermined rate when the object is not detected or the object is not located in the at least one of the plurality of overlap areas to generate an around view image.

16. The vehicle of claim 15, wherein when the object is detected in the at least one of the plurality of overlap areas of the plurality of images, the controller compares at least one of movement speeds, movement directions, and sizes of the object in the plurality of images, determines a specific image of the plurality of images having higher reliability than other images of the plurality of images, and processes the at least one of the plurality of overlap areas based on the higher reliability of the specific image.

17. The vehicle of claim 16, wherein the controller processes the at least one of the plurality of overlap areas only with the specific image having the higher reliability.

18. The vehicle of claim 17, wherein when the controller determines reliability based on the movement speed, the controller assigns a higher reliability rating to the specific image of the plurality of images having a larger pixel movement per unit of time compared to the other images of the plurality of images.

19. The vehicle of claim 17, wherein when the controller determines reliability based on the movement direction, the controller assigns a higher reliability rating to the specific image of the plurality of images having a larger horizontal movement compared to the other images of the plurality of images.

20. The vehicle of claim 17, wherein when the controller determines reliability based on the size, the controller assigns a higher reliability rating to the specific image of the plurality of images having a larger number of pixels occupied by the object compared to the other images of the plurality of images.
